(19) United States
(12) Patent Application Publication
(10) Pub. No.: US 2026/0102772 A1
(43) Pub. Date: Apr. 16, 2026

(54) SAMPLE TRAY FOR AUTOMATED OR SEMI-AUTOMATED SAMPLE PREPARATION AND TESTING

(71) Applicant: TA Instruments-Waters LLC, New Castle, DE (US)

(72) Inventors: Reginald Lee, West Chester, PA (US); Cynthia Waters, West Grove, PA (US)

(21) Appl. No.: 19/231,988

(22) Filed: Jun. 9, 2025

Related U.S. Application Data
(60) Provisional application No. 63/657,444, filed on Jun. 7, 2024.

(51) Int. Cl. B01L 3/00

(52) U.S. Cl. CPC B01L 3/5085; B01L 2200/0689; B01L 2200/08; B01L 2200/12; B01L 2300/045; B01L 2300/0829

(57) ABSTRACT

A sample tray for thermal analysis includes a tray body including a plurality of wells, wherein each well is configured to receive a sample pan and a sample lid. The sample pan is configured to receive a sample for thermal analysis, wherein the sample lid is configured to be crimped to the sample pan to create a seal between the sample lid and the sample pan, and the tray body is configured to be received into an automated sample preparation system to prepare samples for thermal analysis. A method of manufacturing a sample tray is also disclosed.

### RELATED APPLICATION

This application claims priority to U.S. Provisional Patent Application No. 63/657,444 filed on Jun. 7, 2024 and titled “Pre-filled and Pre-weighted Multiple Sample Tray for Automated or Semi-Automated Sample Preparation and Testing” the entirety of which is incorporated by reference herein.

### FIELD OF THE INVENTION

The disclosed technology generally relates to thermal analytical instruments performing analysis such as differential scanning calorimetry (DSC) or simultaneous differential scanning calorimetry and thermogravimetric analysis (SDT). More particularly, the technology relates to sample trays for automated or semi-automated sample preparation and testing.

### BACKGROUND

Approximately 30 manual steps are currently required prepare each sample of interest for accurate DSC measurement. This includes handling of small pans and lids, weighing and recording the mass of the pan, lid and sample, and crimping of the sample pan. Preparing a full set of samples (up to 54 per tray) is time consuming, tedious, and prone to errors.

For accurate DSC measurements, for example, the sample of interest should be of a precise weight and enclosed within a suitable sample pan. The sample pan should also be weighed along with the lid. The sample pan is then crimped or sealed using a manual press to isolate it from the environment. This sample preparation is currently fully manually performed by a skilled user or lab technician. A hand tweezer is often utilized to retrieve a small pan (˜5-8 mm diameter) from the supply box and place the pan on a scale, weigh the pan on the scale and document the result, manipulate the small sample (typically single digit uL) into the pan, weigh the pan and sample on the scale again and document the result, manipulate a small lid from the supply box onto the pan, weigh the pan and sample and lid on the scale and document the result, manipulate the sample pan and lid into a manual crimper, crimp the pan, then return the crimped pan to the sample tray. After this manual process, the single sample is finally prepared and ready for testing. Prior to testing, a reference material may also be needed for instrument calibration which is formed in a similar fashion. When multiple samples are prepared in this method, the user or lab technician can then start the testing. The same or similar lengthy and difficult manual processes exists for other thermal instruments such as SDT, thermogravimetric analysis (TGA), and simultaneous thermal analysis (SA).

Therefore, sample trays for automated or semi-automated sample preparation and testing and methods for manufacture thereof would be well received in the art.

### SUMMARY

In one aspect, a sample tray for thermal analysis includes a tray body including a plurality of wells, wherein each well is configured to receive a sample pan and a sample lid, where the sample pan is configured to receive a sample for thermal analysis, and the sample lid is configured to be crimped to the sample pan to create a seal between the sample lid and the sample pan, and the tray body is configured to be received into an automated sample preparation system to prepare samples for thermal analysis.

Additionally or alternatively, the sample lid is configured to be retained below the sample pan in each well.

Additionally or alternatively, the sample tray includes a plurality of sample pans, each individually located within one of the plurality of wells of the tray body.

Additionally or alternatively, a plurality of sample lids, each individually located within one of the plurality of wells of the tray body.

Additionally or alternatively, each of the plurality of sample lids are located below one of the plurality of sample pans within each of the plurality of wells.

Additionally or alternatively, the sample tray includes a peel-off sealing film that seals and covers each of the plurality of wells.

Additionally or alternatively, each of the plurality of wells includes a plurality of reliefs each located radially about a central pan receiver location, where the plurality of reliefs are each configured to facilitate receiving a finger of an automated gripping system.

Additionally or alternatively, each of the plurality of wells includes three reliefs each equally spaced about the central pan receiver location.

Additionally or alternatively, the sample tray includes an identification code located on the tray body in a location viewable by a vision system of the automated sample preparation system.

Additionally or alternatively, the identification code is an embedded QR code, barcode or numerical ID located on the tray body.

Additionally or alternatively, the tray body is an injection molded thermoplastic body.

Additionally or alternatively, the sample tray includes a metallic base layer, wherein the tray body is coupled to the metallic base layer.

Additionally or alternatively, the tray body is Society of Laboratory and Automation (SLAS) compatible.

Additionally or alternatively, the plurality of wells are located in a two dimensional array having a plurality of rows and a plurality of columns.

In another aspect, a sample tray for thermal analysis includes a tray body including a plurality of wells; a plurality of sample pans, each individually located within one of the plurality of wells of the tray body; and a plurality of sample lids, each individually located within one of the plurality of wells of the tray body. Each of the plurality of sample lids are located below one of the plurality of sample pans within each of the plurality of wells.

Additionally or alternatively, the sample tray includes a peel-off sealing film that seals and covers each of the plurality of wells.

Additionally or alternatively, each of the plurality of wells includes a plurality of reliefs each located radially about a central pan receiver location, wherein the plurality of reliefs are each configured to facilitate receiving a finger of an automated gripping system.

Additionally or alternatively, each of the plurality of wells includes three reliefs each equally spaced about the central pan receiver location.

Additionally or alternatively, the sample tray includes an identification code located on the tray body in a location viewable by a vision system of the automated sample preparation system.

In another aspect, a method of manufacturing a sample tray for thermal analysis includes: injection molding a tray body including a plurality of wells wherein each well is configured to receive a sample pan and a sample lid. The sample pan is configured to receive a sample for thermal analysis, and the sample lid is configured to be crimped to the sample pan to create a seal between the sample lid and the sample pan. The tray body is configured to be received into an automated sample preparation for thermal analysis.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic view of a thermal analysis system, in accordance with one embodiment.

FIG. 2A depicts a first step in a first workflow using the thermal analysis system of FIG. 1, in accordance with one embodiment.

FIG. 2B depicts a second step in the first workflow using the thermal analysis system of FIG. 1, in accordance with one embodiment.

FIG. 2C depicts a third step in the first workflow using the thermal analysis system of FIG. 1, in accordance with one embodiment.

FIG. 2D depicts a fourth step in the first workflow using the thermal analysis system of FIG. 1, in accordance with one embodiment.

FIG. 2E depicts a fifth step in the first workflow using the thermal analysis system of FIG. 1, in accordance with one embodiment.

FIG. 2F depicts a sixth step in the first workflow using the thermal analysis system of FIG. 1, in accordance with one embodiment.

FIG. 2G depicts a seventh step in the first workflow using the thermal analysis system of FIG. 1, in accordance with one embodiment.

FIG. 2H depicts a eighth step in the first workflow using the thermal analysis system of FIG. 1, in accordance with one embodiment.

FIG. 2I depicts a ninth step in the first workflow using the thermal analysis system of FIG. 1, in accordance with one embodiment.

FIG. 2J depicts a tenth step in the first workflow using the thermal analysis system of FIG. 1, in accordance with one embodiment.

FIG. 2K depicts an eleventh step in the first workflow using the thermal analysis system of FIG. 1, in accordance with one embodiment.

FIG. 2L depicts a twelfth step in the first workflow using the thermal analysis system of FIG. 1, in accordance with one embodiment.

FIG. 2M depicts a thirteenth step in the first workflow using the thermal analysis system of FIG. 1, in accordance with one embodiment.

FIG. 2N depicts a fourteenth step in the first workflow using the thermal analysis system of FIG. 1, in accordance with one embodiment.

FIG. 2O depicts a fifteenth step in the first workflow using the thermal analysis system of FIG. 1, in accordance with one embodiment.

FIG. 2P depicts a sixteenth step in the first workflow using the thermal analysis system of FIG. 1, in accordance with one embodiment.

FIG. 3A depicts a first step in a second workflow using the thermal analysis system of FIG. 1, in accordance with one embodiment.

FIG. 3B depicts a second step in the second workflow using the thermal analysis system of FIG. 1, in accordance with one embodiment.

FIG. 3C depicts a third step in the second workflow using the thermal analysis system of FIG. 1, in accordance with one embodiment.

FIG. 3D depicts a fourth step in the second workflow using the thermal analysis system of FIG. 1, in accordance with one embodiment.

FIG. 3E depicts a fifth step in the second workflow using the thermal analysis system of FIG. 1, in accordance with one embodiment.

FIG. 3F depicts a sixth step in the second workflow using the thermal analysis system of FIG. 1, in accordance with one embodiment.

FIG. 3G depicts a seventh step in the second workflow using the thermal analysis system of FIG. 1, in accordance with one embodiment.

FIG. 3H depicts a eighth step in the second workflow using the thermal analysis system of FIG. 1, in accordance with one embodiment.

FIG. 3I depicts a ninth step in the second workflow using the thermal analysis system of FIG. 1, in accordance with one embodiment.

FIG. 3J depicts a tenth step in the second workflow using the thermal analysis system of FIG. 1, in accordance with one embodiment.

FIG. 3K depicts an eleventh step in the second workflow using the thermal analysis system of FIG. 1, in accordance with one embodiment.

FIG. 3L depicts a twelfth step in the second workflow using the thermal analysis system of FIG. 1, in accordance with one embodiment.

FIG. 3M depicts a thirteenth step in the second workflow using the thermal analysis system of FIG. 1, in accordance with one embodiment.

FIG. 4 depicts a perspective view of the thermal analysis system of FIG. 1, in accordance with one embodiment.

FIG. 5 depicts a perspective view of the thermal analysis system of FIG. 4, in accordance with one embodiment.

FIG. 6 depicts a perspective view of a sample tray for the thermal analysis system of FIG. 4, in accordance with one embodiment.

FIG. 7 depicts a side cutaway view of two wells of the sample tray of FIG. 6, in accordance with one embodiment.

FIG. 8 depicts an enlarged perspective view of a gripper system picking up a pan from a well in the sample tray of FIG. 6, in accordance with one embodiment.

FIG. 9 depicts a perspective view of the gripper system of FIG. 8 placing the pan into a balance module system, in accordance with one embodiment.

FIG. 10 depicts a side view of a balance module, in accordance with one embodiment.

FIG. 11 depicts a side cutaway view of the balance module of FIG. 10, in accordance with one embodiment.

FIG. 12 depicts a perspective view of a crimper module of the thermal analysis system of FIG. 4-5, in accordance with one embodiment.

FIG. 13 depicts a side cutaway view of the another crimper module, in accordance with one embodiment.

FIG. 14A depicts a perspective view of a Hermetic die holding a pan, in accordance with one embodiment.

FIG. 14B depicts a perspective view of a modified die holding a pan, in accordance with one embodiment.

FIG. 15A depicts a perspective view of a crimped pan, in accordance with one embodiment.

FIG. 15B depicts a perspective view of a pan crimped by the modified die, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein may include several components an autosampler which can manipulate sample and reference pans, sample and reference lids, and samples and/or reference samples; an integrated scale with sufficient precision to measure samples, sample pans, sample lids, and reference samples individually or in combination and communicates with the instrument; a powered sample pan crimper which can combine the DSC pan and its associated lid; and optionally a camera or laser based barcode reader which can identify the tray, pan, lid, sample and it's characteristics.

The combination of the first three of these components (the autosampler, the integrated scale and the powered sample plan crimper) allows for the automatic or semi-automatic preparation of the DSC sample pans which includes weighing the pan, weighing the pan and sample, weighing the pan, sample, and lid, crimping the lid, returning the prepared sample pan to a testing queue and/or directly into a testing position, and the associated manipulation of each of those components to accomplish this. These steps can be performed prior to DSC testing, after DSC testing, or as an independent step to prepare samples. It is envisioned that this system may be utilized largely autonomously and automatically, with some user interaction (for example, sample loading and loading of the tray into the system), or with a separate lab automation system (for example, the Andrew+TM robot which can load liquid samples into the sample pans and place the tray of pans directly into this system) to achieve various levels of automation. All referenced qualities are also applicable to TGA, SDT, and SA samples, sample pans, and sample trays.

Contemplated herein is an automatic sample preparation system built into the thermal instrument (DSC, TGA, etc.) to significantly improve ease of use and reduce errors in DSC, TGA, and/or thermal testing. Embodiments contemplated herein include expanded autosampler functionality for pan/lid/reference sample manipulation, and integrated scale operably connected to a computer system for automatic weight measurements, an automatic crimper to seal sample pans, and an automation ready tray with pans, lids, reference samples and a QR code visibly located on the tray.

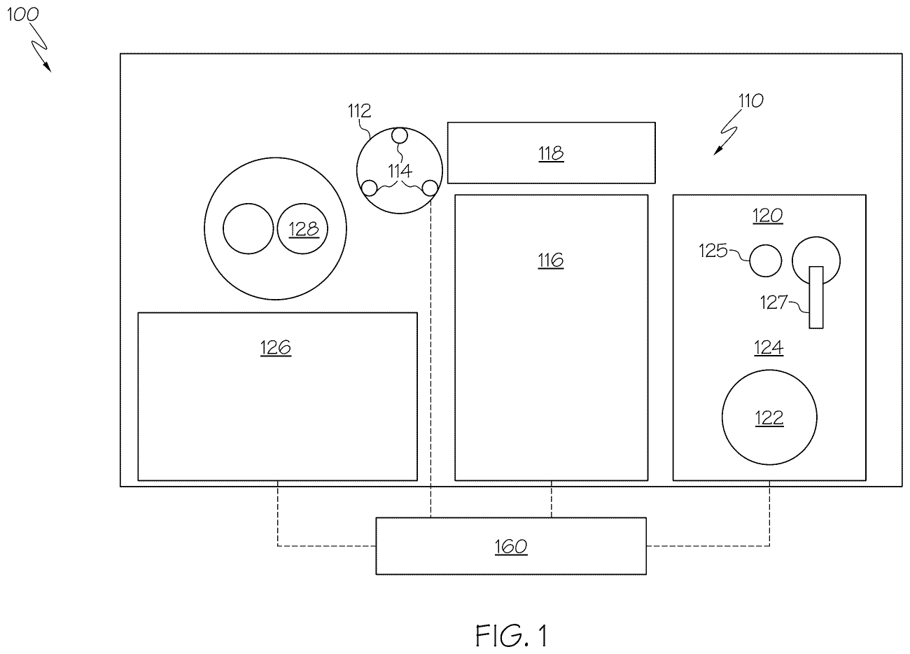

FIG. 1 depicts a schematic view of a thermal analysis system 100, in accordance with one embodiment. The thermal analysis system 100 may comprise an automated sample preparation system 110 including an autosampler 112 having an automated gripping system 114, a tray module 116 including a tray cover 118, a sample preparation module 120 including a balance module 122 and a crimper module 124. The thermal analysis system 100 and/or automated sample preparation system 110 thereof may further include a user interface 126 which may include a display and user input interface. Further, the thermal analysis system 100 includes a thermal sensor system 128 having at least one thermal sensor. Still further, the various components 114, 116, 118, 120, 122, 124, 126, 128 of the thermal analysis system 100 and/or automated sample preparation system 110 may be operably connected to a computer system 130 and/or instrument controller which may be configured to control these components 114, 116, 118, 120, 122, 124, 126, 128 in the manner described herein.

The thermal analysis system 100 may be any type of thermal analysis system such as a DSC, TGA, SDT, and/or SA system. The present automation solutions of the automated sample preparation system 110 described herein may be particularly advantageous to apply in DSC instruments to significant improve the ease of use and reduce errors in testing. In such an embodiment, for example, the thermal sensor system 128 may be a DSC sensor system which is configured to receive a DSC sample pan having a sample contained therein, and perform thermal testing on the sample.

The autosampler 112 may include any type of gripping system 114 which may be configured to pick up a sample pan and/or sample lid, for example from a well or sample tray. The autosampler 112 may be a multi axis moving component configured to move along a first X axis to the left and right of the thermal analysis system 100, a second Y axis to the top and bottom of the thermal analysis system 100, and a third Z axis which may move the gripping system 114 toward (downward) and away (upward) from the working surface(s) of the thermal analysis system 100.

While the embodiment shown includes a gripping system 114 having three elongated gripping elements, fingers or the like, any number of gripping fingers may be utilized in order to pick up and place pans and/or lids of pans in accordance to the methods described herein. The gripping elements and/or fingers of the gripping system 114 may provide for picking up circular pans having various diameters, such as 5-8 mm. The finger diameter of the individual gripping fingers of the gripping system 114 may be, for example, 0.8 mm, 1.3 mm, 1.8 mm or the like. The gripping elements and/or fingers of the gripping system 114 may thereby be configured to move relative each other in order to perform picking and placing the pans and/or lids. In various embodiments, the griping elements and/or fingers of the gripping system 114 may be programmed to move between a closed position where a pan or lid is gripped or picked up, and an open position where the pan or lid is let go and/or open in a pre-picking position.

The tray module 126 may be configured to receive a sample tray containing a plurality of pans and/or pan lids. The tray module 118 may include a tray cover 118 which may be configured to automatically or manually open and close to protect a tray that has been received within the tray module 118 when the autosampler 112 is not interacting with the tray module 118. The tray cover 118 may be configured to slide across the tray module 116 using an automated sliding rail system controlled by the computer system 130.

The sample preparation module 120 may include one or both of the balance module 122 and the crimper module 124 in various embodiments contemplated herein. Each of these two separate modules 122, 124 may provide for the automation of various sample preparation steps. The sample preparation module 120 may be an additional module added to a thermal analysis system 100, or the combination of the sample preparation module 120 and the thermal sensor system 128 and/or thermal analysis system 100 may be combined into a single integrated system.

The balance module 122 of the sample preparation module 120 may be configured to receive a pan and perform weight measurements on the pan. The balance module 122 may include a balance adapter including a stem extending to an adapter top which includes a measurement adapter configured to receive a pan. In some embodiments, the adapter top may include an overspill tray configured to retain spillage of sample being placed within a received pan. The balance module 122 may be configured to weigh a sample and/or sample within a pan, within 0.01 mg accuracy and repeatability, despite normal system vibrations. Moreover, the balance module 122 may be connected to the computer system 130, which may receive a balance signal from the balance adapter associated with the weight of the pan. The balance signal may be filtered by the computer system 130 in order to determine the exact weight within the configured accuracy. The computer system 130 and/or the balance module 122 may be further configured to determine if covers/isolation or enhanced filtering are needed to meet the accuracy requirements. Overall, the computer system 130 may further be configured to collect and store data associated with the weights of the pans and/or samples therein. While not shown in the Figures, it is further contemplated that the balance module 122 may include its own covering system in order to enable more precise weight measurements. This covering system may operate in a similar manner to the tray cover, and may be a manual covering system or an automated covering system.

The crimper module 124 of the sample preparation module 120 may be configured to seal a received pan with an automation crimping process. The crimper module 124 may include an upper crimp 125 and a lower crimp 127 which may be configured to move into a crimp (closed) position and an open position. In various embodiments, the crimper module 124 may include a swing arm in order to ensure that the autosampler 112 and/or the gripping system 114 thereof obtains access to a crimping location. The crimper module 124 may be configured to receive various crimper dies which may each be configured to crimp pans in various different ways. Whatever the embodiment, the crimper module 124 may be configured to crimp the lid and the pan to attach the lid to the pan. In various embodiments, the crimping may include compressing, by the automated system, the upper crimp 127 and the lower crimp 125, and cold welding, by the compression of the upper crimp 127 and the lower crimp 125, a flange of the pan with a flange of the lid to create a hermetic seal between the lid and the pan.

While the embodiment shown in the various Figures described herein includes both the balance module 122 and the crimper module 124, there are various systems and methods contemplated herein which may only use one of these modules. For example, an automated sample preparation method and/or system may only utilize the balance module. There may be systems and methods whereby a pan does not require a lid and/or the sealing thereof. In such methods and systems, the functionality and automation of the balance module 122 and the autosampler 112 and the like may operate as provided herein, without the additional sealing steps and/or crimping module structure. Likewise, systems and methods contemplated herein may utilize the crimper module 124 described herein without the balance module 122.

While not shown, the computer system 130 may include one or more processors, non-transitory computer readable medium or memory, I/O interface devices (e.g., wireless communications, etc.) and one or more network interfaces. The computer readable medium may include an operating system, running one or more software applications in accordance with the systems and methods described herein. In operation, the processor may execute the application stored in the computer readable medium. The application may include software instructions that, when executed by the processor, cause the processor to perform operations for automating the thermal analysis system 100 in the manner described herein, including controlling the user interface 126 thereof, and storing test results of testing performed after sample preparation. The application program may operate in conjunction with a database or storage system of the computer system 130 and the operating system thereof.

The computer system 130 described herein may include one or more actual computer devices. For example, the computer system 130 may include an instrument controller system or computer system located onboard or otherwise integrated within the thermal analysis system 100. Additionally or alternatively, the computer system 130 may also include a connected computer (e.g., a wired or wireless desktop, laptop and/or tablet) that is networked and/or otherwise connected to the thermal analysis system 100. Additionally or alternatively, the computer system 130 may include one or more cloud computing devices operably connected to the thermal analysis system 100 for performing application and/or computing and/or storage of data.

The computer system 130 may be configured to control a control system or controller which moves the gripping system 114, the crimper module 120, and the autosampler 112. For example, the computer system 130 may be in operable communication with a crimper controller configured to move the crimper down until a precision stop switch is reached. The computer system 130 may be further provide a signal to the crimper module controller to move the crimper back up to a desired location using a hall sensor encoder. Therefore, the computer system 130 may ultimately control the operation of the crimper microcontroller to enable automated crimping and automated controlling of the upper and/or lower crimps thereof.

As described above, the computer system 130 may further be configured to collect and store data associated with the weights of the pans and/or samples therein. The computer system 130 may be configured to record information associated with the specific pan and/or pan location within a sample tray is being prepared. For example, if the top left well in the tray module is being prepared, the computer system 130 may be configured to store information related to that preparation (e.g., sample weight, etc.) associated with the top left tray location.

The computer system 130 may be able to track and collect individualized data associated with the samples prepared in each tray position. Thus, the computer system 130 may be configured to maintain a database storing weight measurements performed by the balance module 122 and may further associate the weight measurements with a location of the well in the sample tray.

The computer system 130 may further be operably connected to a camera or barcode reader (e.g., a laser based barcode reader) which can identify the tray, pan, lid, sample and it's characteristics. The camera or barcode reader may be operably coupled to the autosampler 112. The camera or barcode reader may thereby be configured to obtain an identification code of the sample tray prior to performing an automated sample preparation procedure.

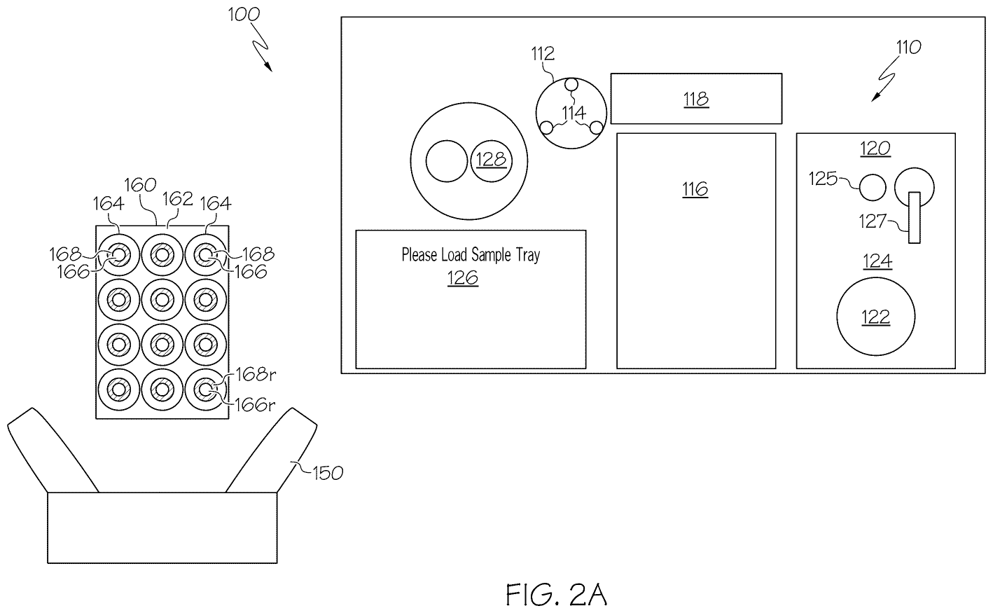

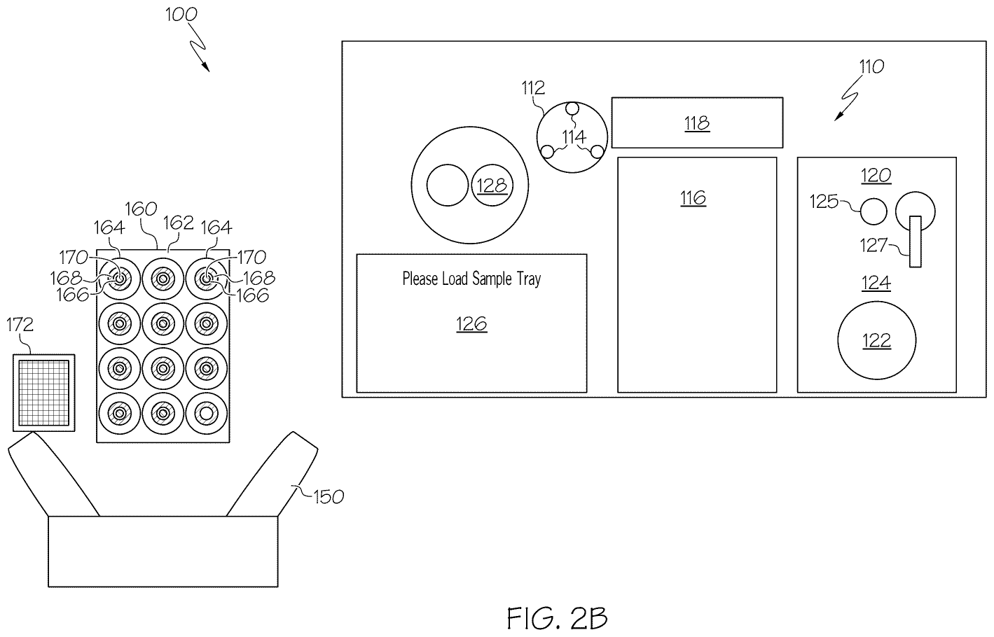

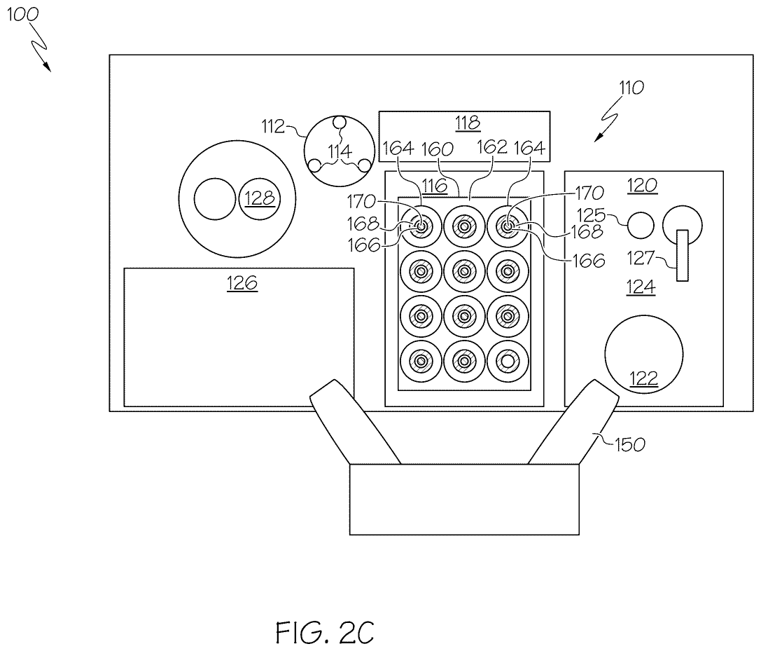

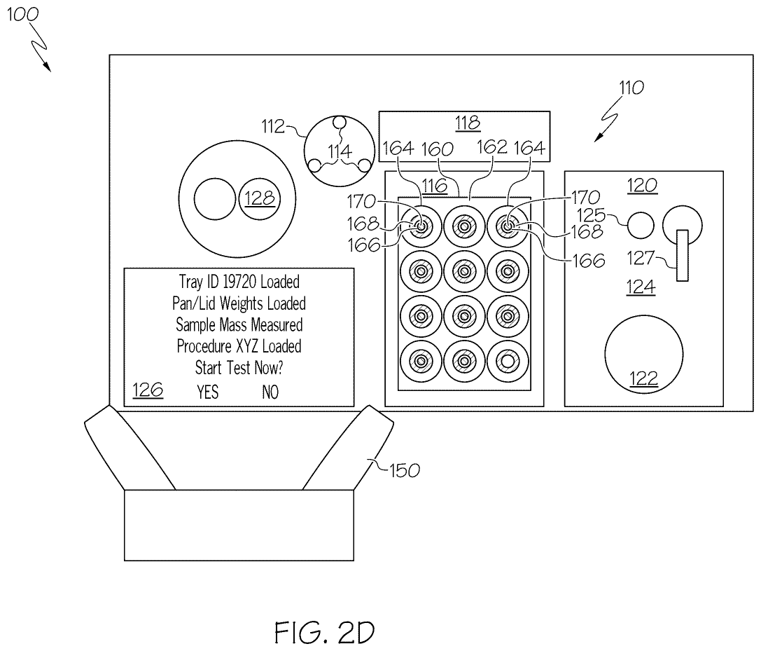

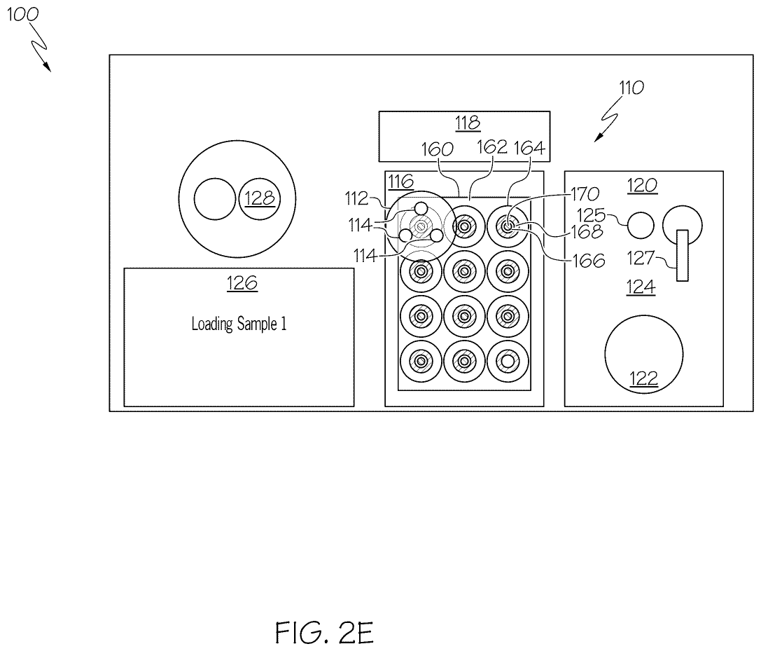

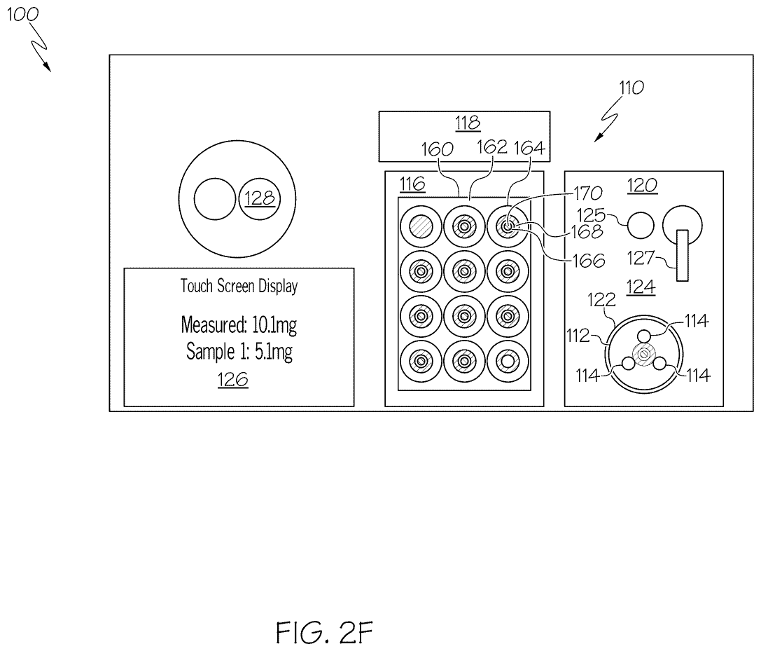

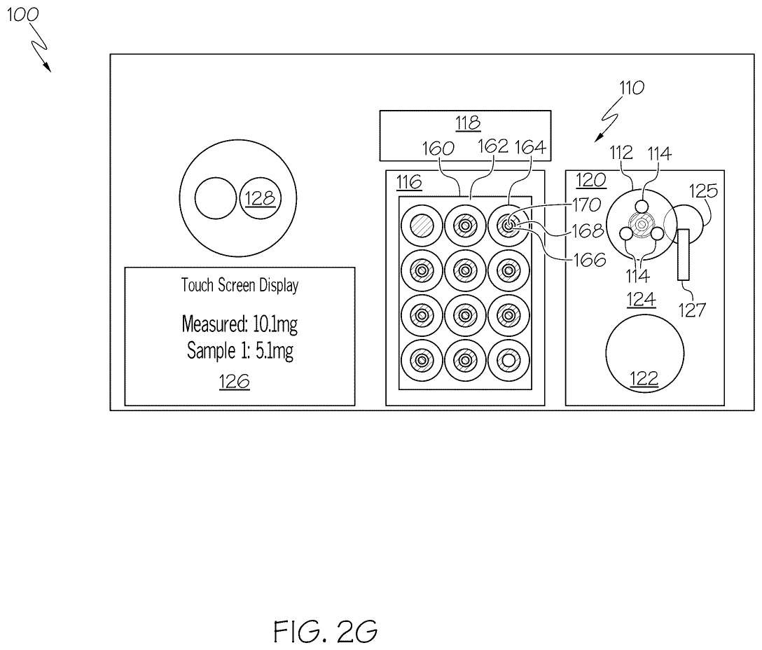

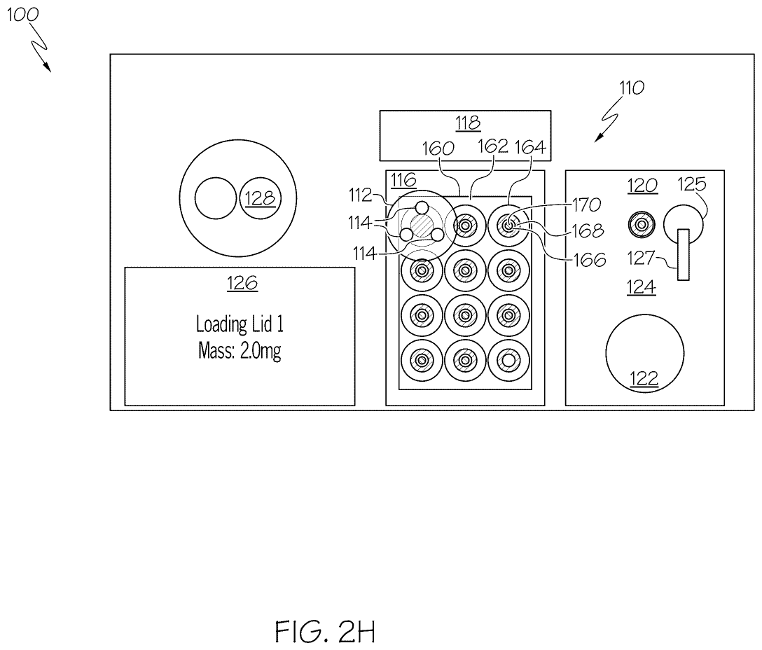

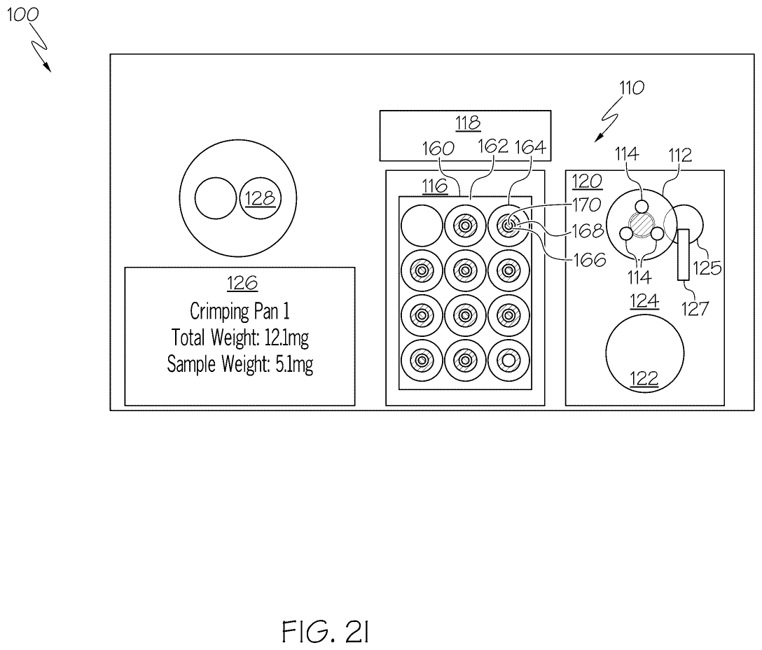

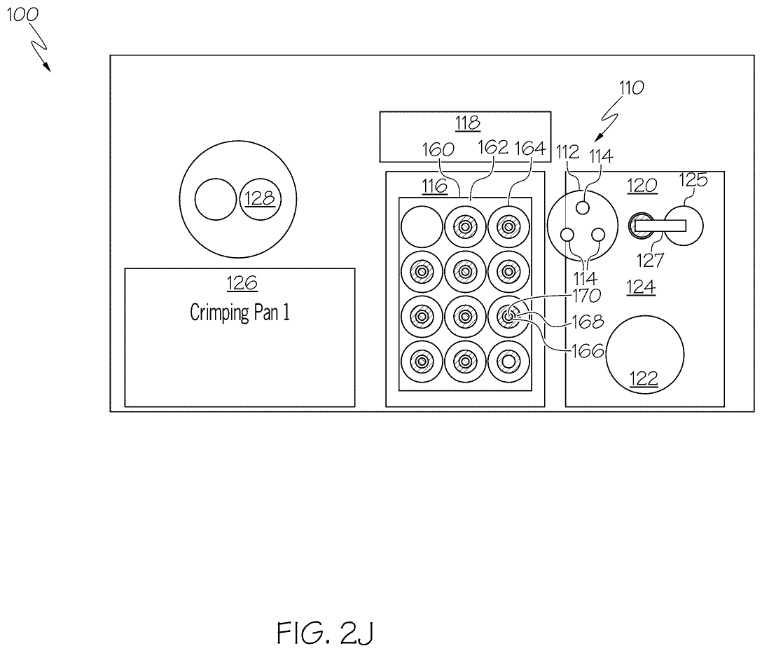

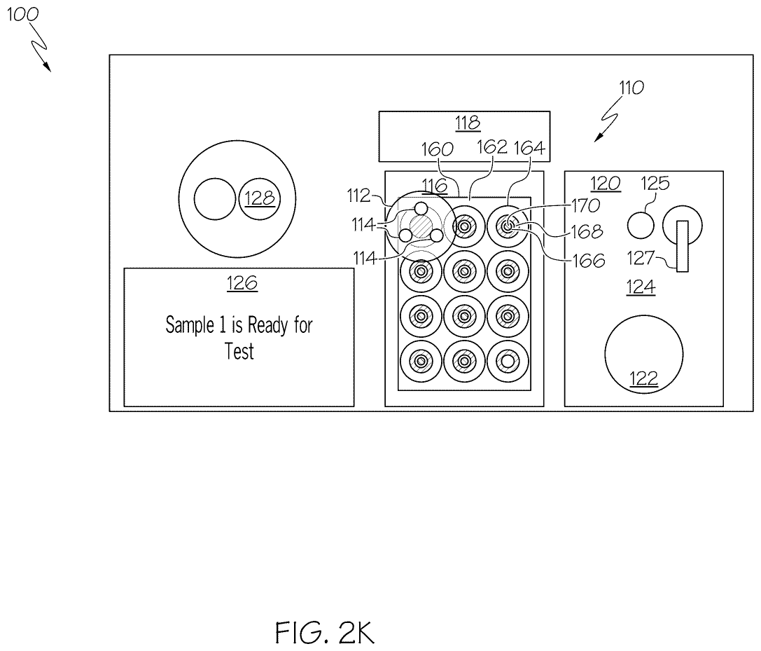

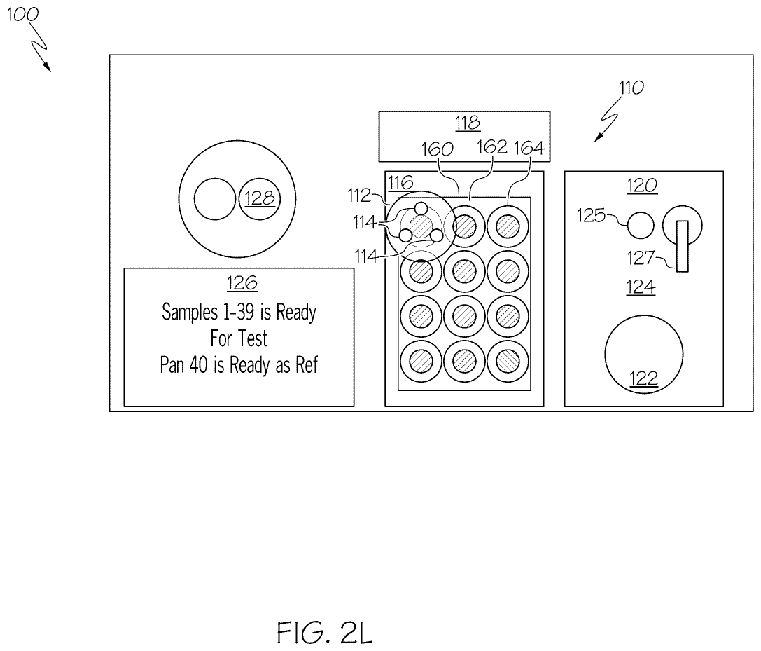

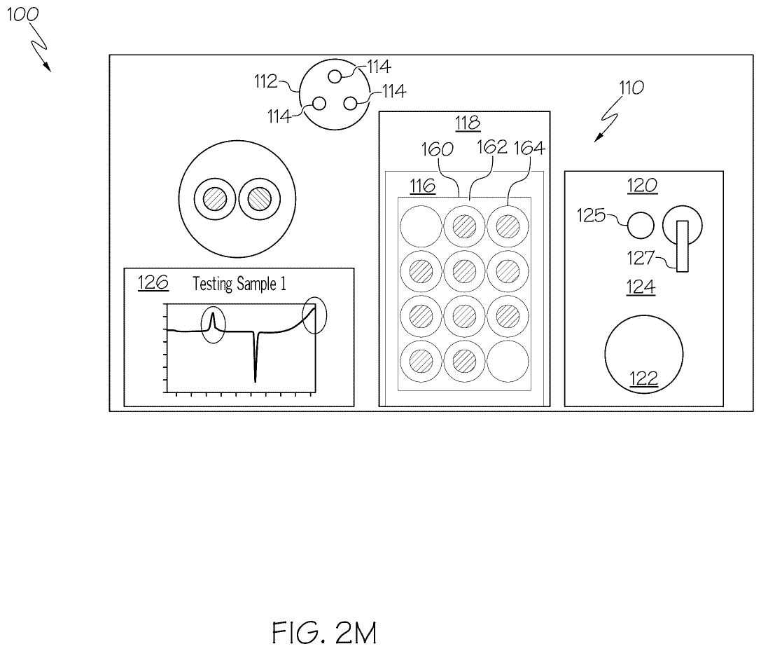

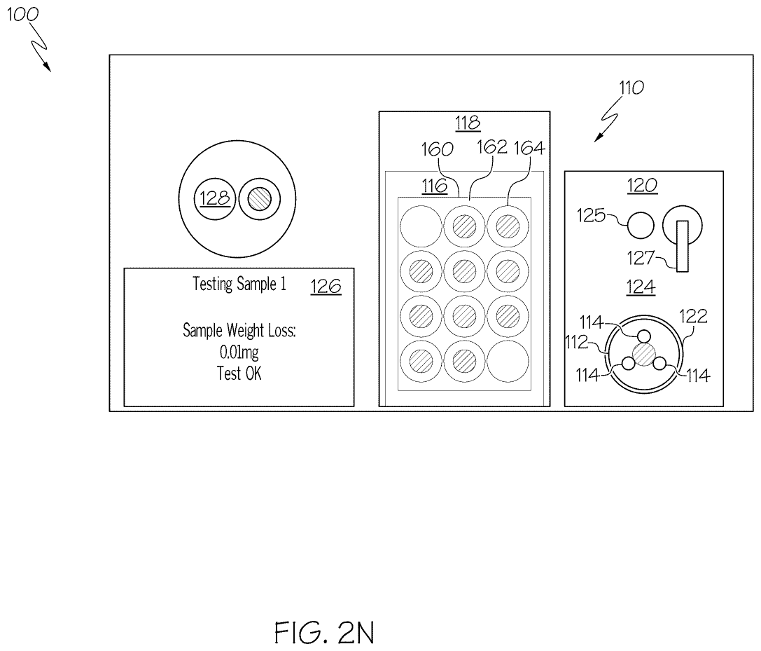

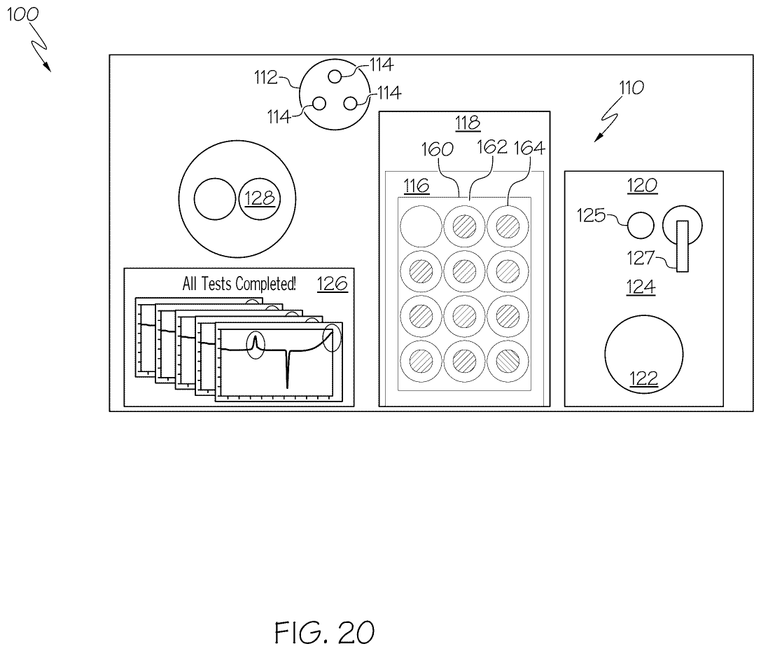

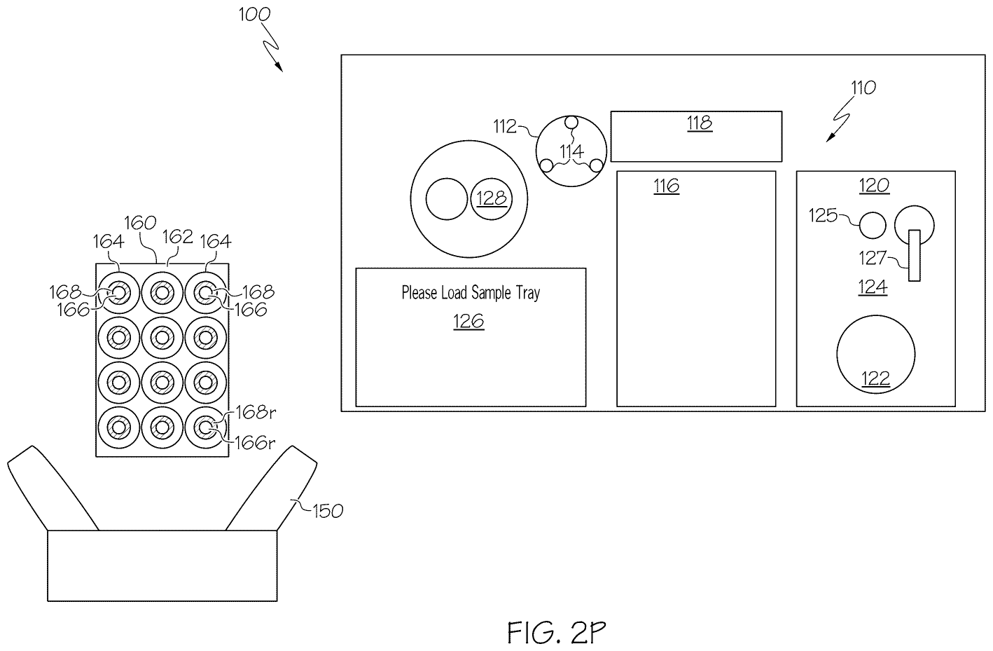

FIG. 2A depicts a first step in a first workflow using the thermal analysis system 100 of FIG. 1, in accordance with one embodiment. In the workflow shown, a user 150 or lab technician is shown holding a sample tray 160 for thermal analysis. The sample tray 160 includes a tray body 162 having a plurality of wells 164. Each well is configured to receive a sample pan 166 and a sample lid 168 therein. As described within the workflow, the sample pan 166 is configured to receive a sample for thermal analysis. The sample lid 168 is configured to be crimped to the sample pan 166 to create a seal between the sample lid 168 and the sample pan 166. The tray body 162 and/or the sample tray 160 is configured to be received into the thermal analysis system 100 and/or the automated sample preparation system 110 thereof to prepare the sample for thermal analysis. In the first step of the workflow, the user or lab technician peels open a sealing film that, prior to peeling off, seals and covers each of the plurality of wells in the sample tray 160. Further, shown in the first step, the user interface 126 of the thermal analysis system 100 includes instructions to the user 150 to load the sample tray 160 into the tray module 116.

FIG. 2B depicts a second step in the first workflow using the thermal analysis system 100 of FIG. 1, in accordance with one embodiment. In the second step, the user 150 or lab technician is shown placing a polymer pellet or sample 170 from a sample bank 172 into each sample pan 166 within each well 164 except for a reference well 164r, which includes a pan 166r which remains empty.

FIG. 2C depicts a third step in the first workflow using the thermal analysis system of 100 FIG. 1, in accordance with one embodiment. In the third step, the user 150 or lab technician places the sample tray 160 within the tray module 116 of the automated sample preparation system 110. The tray cover 118 is shown in an open position, exposing the sample tray 160 to the autosampler 112 and the gripping system 114 thereof.

FIG. 2D depicts a fourth step in the first workflow using the thermal analysis system 100 of FIG. 1, in accordance with one embodiment. At this step, the computer system 130 of the thermal analysis system 100 and/or the automated sample preparation system 110 has determined that the sample tray 160 has been loaded into the tray module 116, and has provided new instructions to the user 150. The user interface 126 displays an acknowledgement that the sample tray 160 has been loaded with the pans 166 and lids 168 weighed. The user interface 126 requests for the user 150 or lab technician to respond with a user input (e.g., via a touch screen) “yes” or “no” to the question of whether to start a test now. The user 150 or lab technician presses “yes”to begin the preparation and/or testing.

FIG. 2E depicts a fifth step in the first workflow using the thermal analysis system 100 of FIG. 1, in accordance with one embodiment. During this step, the autosampler 112 picks up a first of the pans 166 with the sample 170 therein. In particular, the three gripping fingers of the gripping system 114 closes onto the pan 166 to pick up the pan 166 automatically.

FIG. 2F depicts a sixth step in the first workflow using the thermal analysis system 100 of FIG. 1, in accordance with one embodiment. During this step, the autosampler 112 moves the picked up pan 166, using the three-axis movement system, over the balance module 122. The autosampler 112 places the pan into the adapter top of the balance module 122, whereby the pan and sample are weighed. Because the computer system 130 already knows the weight of the pan 166 via pre measurements loaded into the system associated with the loaded sample tray, the sample 170 can be accurately weighed by the balance module 122 by taking the combined weight of the sample 170 and the pan 166 and subtracting the weight of the pan 166. As shown, the user interface 126 displays the accurate weight of the total pan 166 and sample 170, as well as the weight of only the sample 170.

FIG. 2G depicts a seventh step in the first workflow using the thermal analysis system 100 of FIG. 1, in accordance with one embodiment. In this step, the pan 166 is once again picked up by the gripping system 114 of the autosampler 112, removing the pan 166 from the balance module 122. The autosampler 112 moves from the balance module 122 to the crimper module 124. The autosampler 112 places the pan 166 onto the lower crimp 125 of the crimper module 124. As shown, the upper crimp 127 is in a rotated state in order to provide clearance for this placement process.

FIG. 2H depicts a eighth step in the first workflow using the thermal analysis system 100 of FIG. 1, in accordance with one embodiment. During this step, the autosampler 112 moves back above the tray module 116 to pick up the lid 168 located in the same well 164 as the previously picked up pan 166 (i.e., the top left well 164). The lid 168 may be stored within the well 164 below the pan 166, for example, when the sample tray 160 is manufactured and packaged, and/or when the sample tray 160 is loaded into the tray module 116.

FIG. 2I depicts a ninth step in the first workflow using the thermal analysis system 100 of FIG. 1, in accordance with one embodiment. During this step, the lid 168 that has been picked up by the gripping system 114 of the autosampler 112 is moved back to the crimper module 124 and placed onto the top of the pan 166 located on the lower crimp 125 thereof.

FIG. 2J depicts a tenth step in the first workflow using the thermal analysis system 100 of FIG. 1, in accordance with one embodiment. During this step, the upper crimp 127 is rotated so that the upper crimp 127 is directly over the lower crimp 125. The upper and lower crimps 127, 125 then converge at a high enough force or pressure to cause cold welding between circumferential flanges of each of the pan 166 and the lid 168 and provide for hermetic sealing. During the crimping process, the autosampler 112 is moved away from the crimper module 124. While not shown, the autosampler 112 may perform steps 5-6 on a second pan during the crimping process. Alternatively, the process may complete preparation of a first pan before moving onto a second pan. Moreover, the order of steps described may be modified. For example, a lid may be placed on a pan while the pan is still located at or on the balance module 122. In such a case, the combined pan and lid may then be moved from the balance module 122 to the crimper module 124 together.

Moreover, while the crimper module 124 may be configured to provide a hermetic seal and/or cold well as described, such an embodiment is not limiting. Other forms of attachment of the lid with the pan are contemplated.

FIG. 2K depicts an eleventh step in the first workflow using the thermal analysis system 100 of FIG. 1, in accordance with one embodiment. During this step, the sealed pan 166 with the weighed sample is returned to the top left position in the sample tray 160 by the gripping system 114 of the autosampler 112. Once returned, the user interface 126 displays a message to the user that the first sample 170 is ready for testing in the first pan 166 (i.e., the top left pan).

FIG. 2L depicts a twelfth step in the first workflow using the thermal analysis system 100 of FIG. 1, in accordance with one embodiment. This “step” in the workflow represents the repeating of steps 5-11 of the above-described workflow on the various other pans 166 within the sample tray 160. The sample tray 160 may be a 40 pan tray, for example, having a single reference pan and 39 sample pans. However, any tray configuration having any number of pans is contemplated.

FIG. 2M depicts a thirteenth step in the first workflow using the thermal analysis system 100 of FIG. 1, in accordance with one embodiment. Here, the prepared samples are then tested using the thermal sensing system 128. In particular, each of the first sample (i.e., the top left sample pan 166) and the reference pan (i.e., the bottom right pan 166r) are loaded into the sensing system 128 automatically using the gripping system 114 of the autosampler 112. The tray cover 118 may automatically extend over the tray module 116 during this step, in order to protect the other samples within the sample tray 160 that are not under test. The sensing system may be a DSC sensing system, for example. The test is run on the first sample 170 within the first pan 166, and the test results may be displayed on the display of the user interface 126.

FIG. 2N depicts a fourteenth step in the first workflow using the thermal analysis system 100 of FIG. 1, in accordance with one embodiment. Optionally, the autosampler 112 may be configured to provide the pan 166 of the tested sample 170 back to the balance module 122 for post-testing weighing, if necessary, whereby the sample weight loss may be determined using the weight found by the balance module 122 and the original weight stored by the computer system 130. This weight loss is displayed by the display of the user interface 126.

FIG. 2O depicts a fifteenth step in the first workflow using the thermal analysis system of FIG. 1, in accordance with one embodiment. This “step” in the workflow represents the repeating of steps 13 and optionally 14 of the above-described workflow on the various other pans 166 within the sample tray 160. Once all of the tests are completed, the display of the user interface 126 displays an “all tests completed” message. It should be understood that the testing data associated with each sample at each position within the sample tray 160 may be stored within the computer system 130 where the test results are associated with the tray position.

FIG. 2P depicts a sixteenth step in the first workflow using the thermal analysis system 100 of FIG. 1, in accordance with one embodiment. At this step, the user 150 or lab technician may then remove the sample tray 160 from the tray module 116. The user 150 or lab technician may then add another sample tray to begin a new preparation and/or testing procedure.

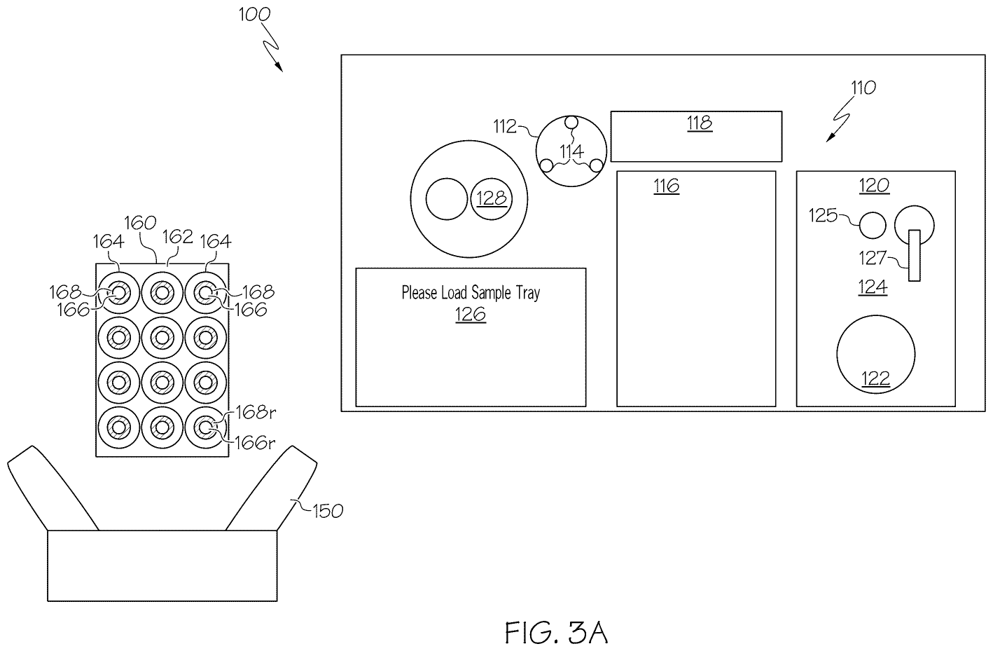

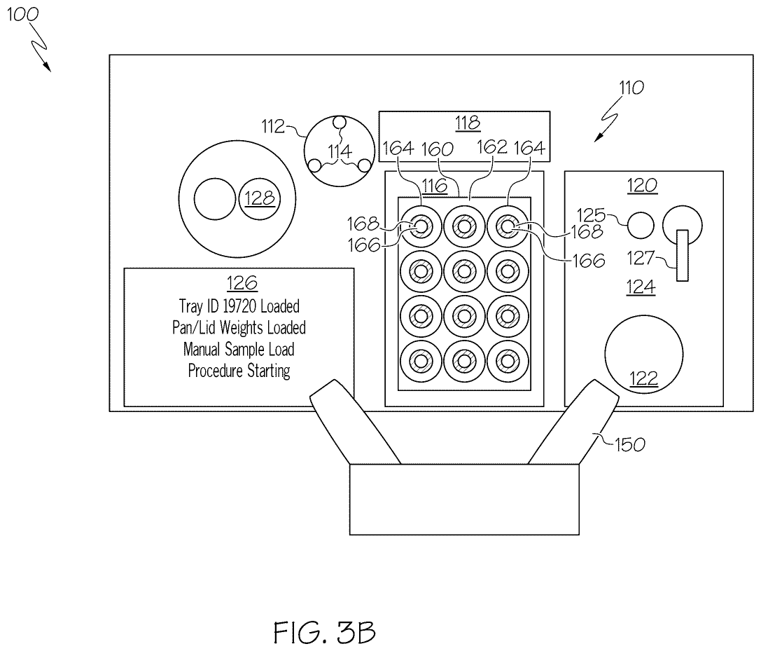

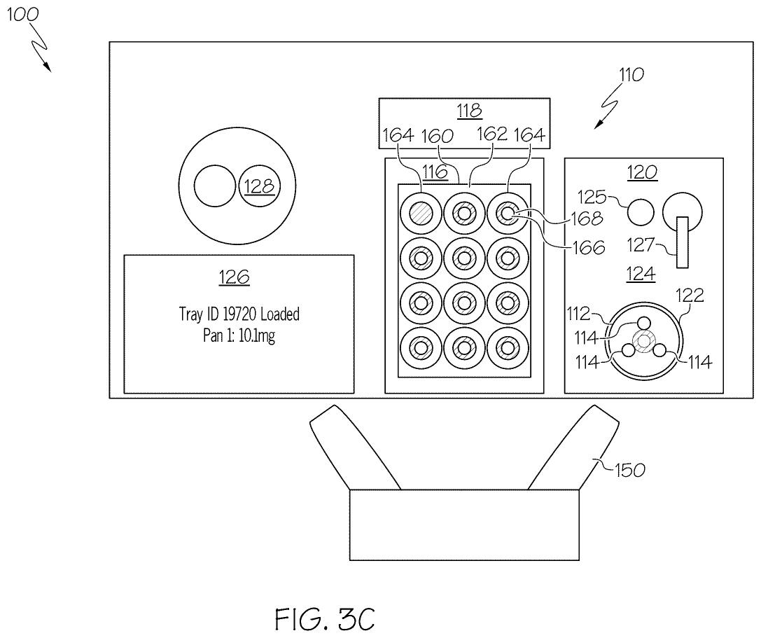

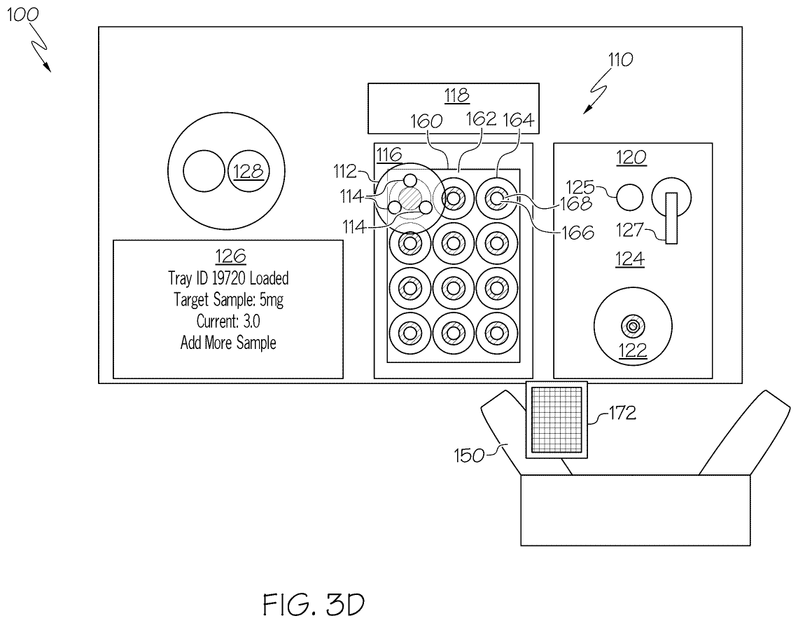

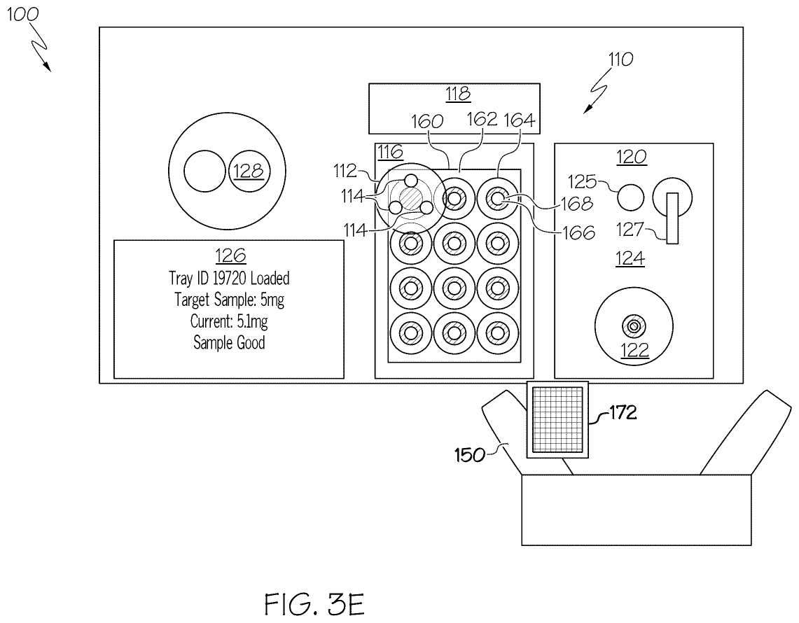

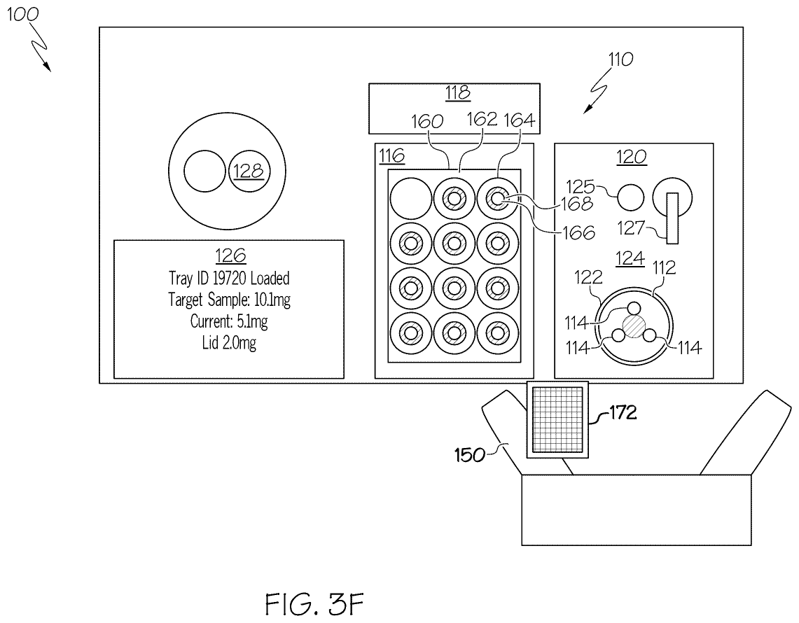

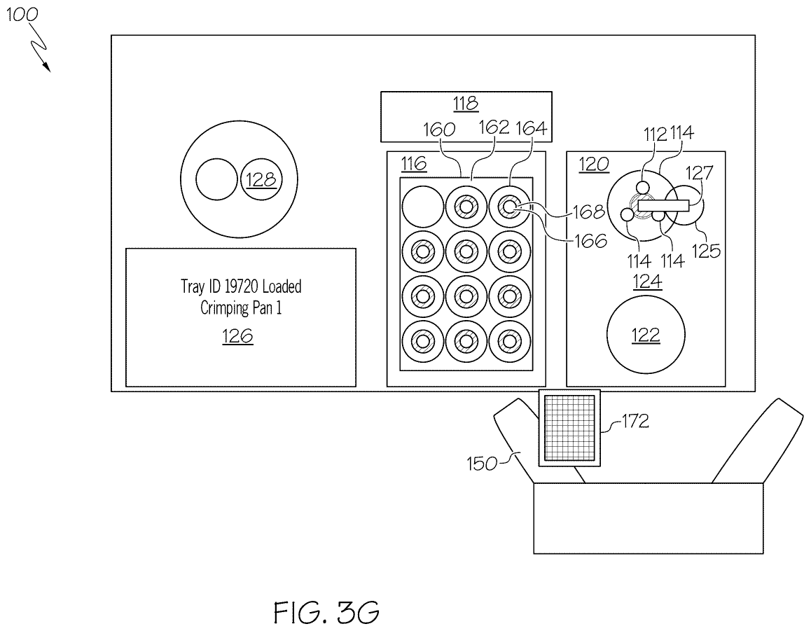

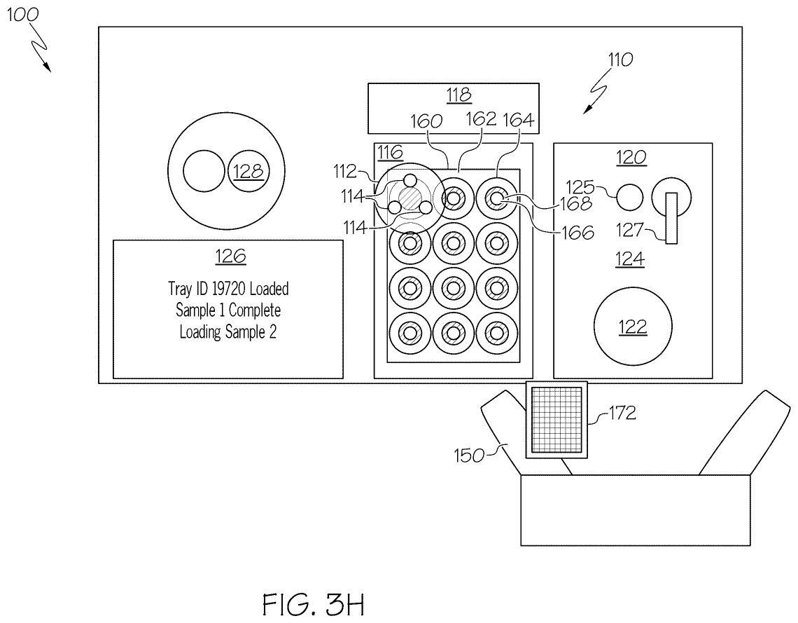

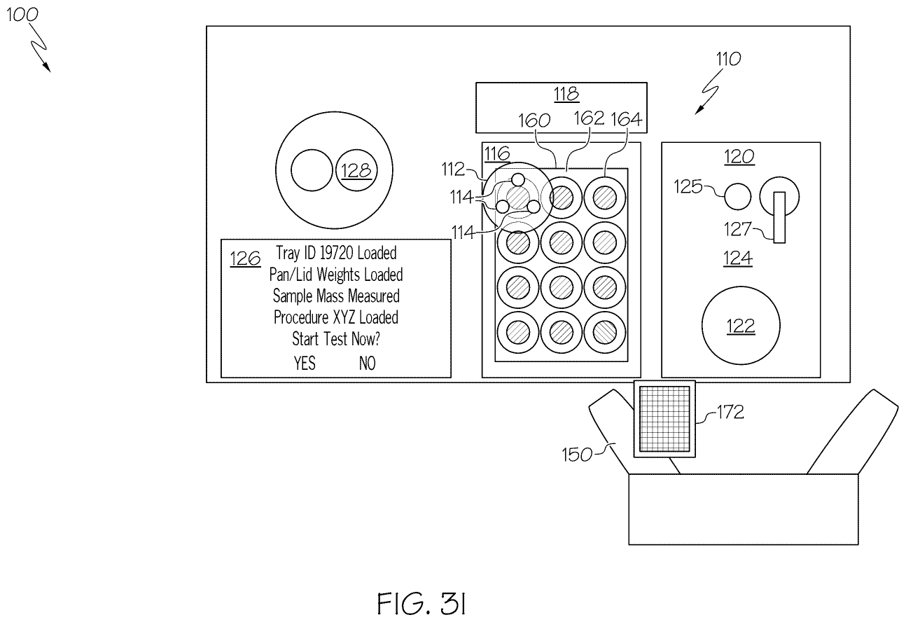

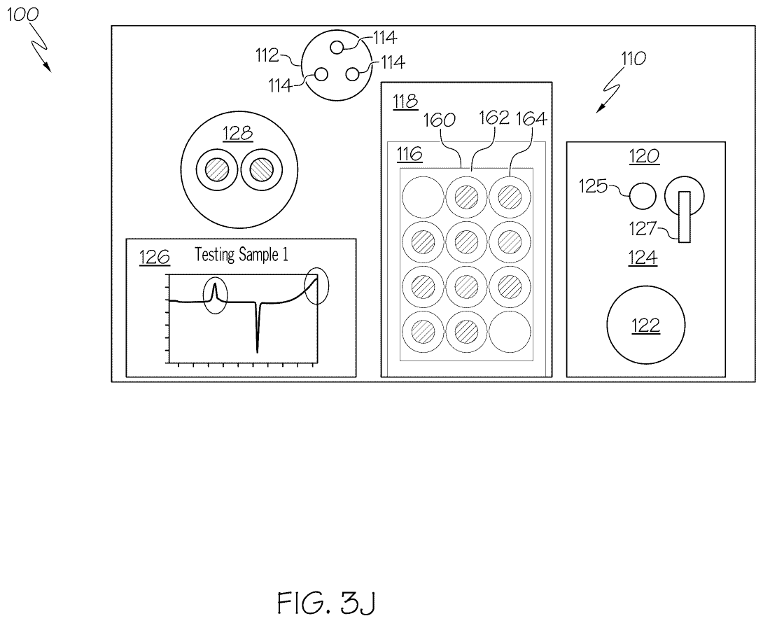

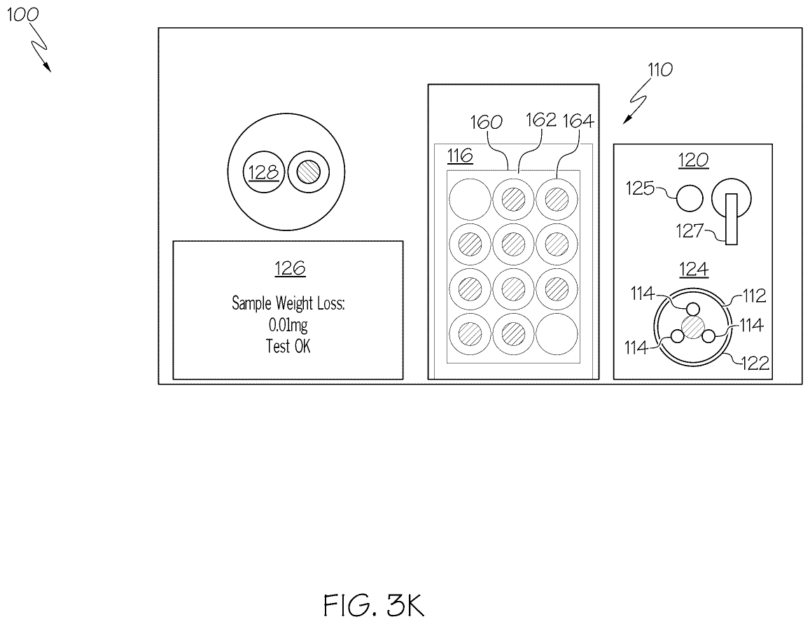

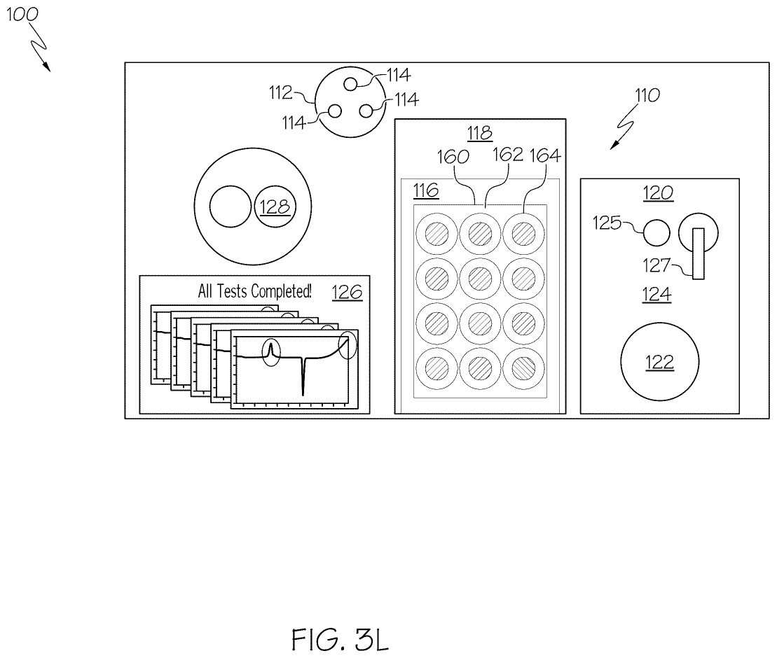

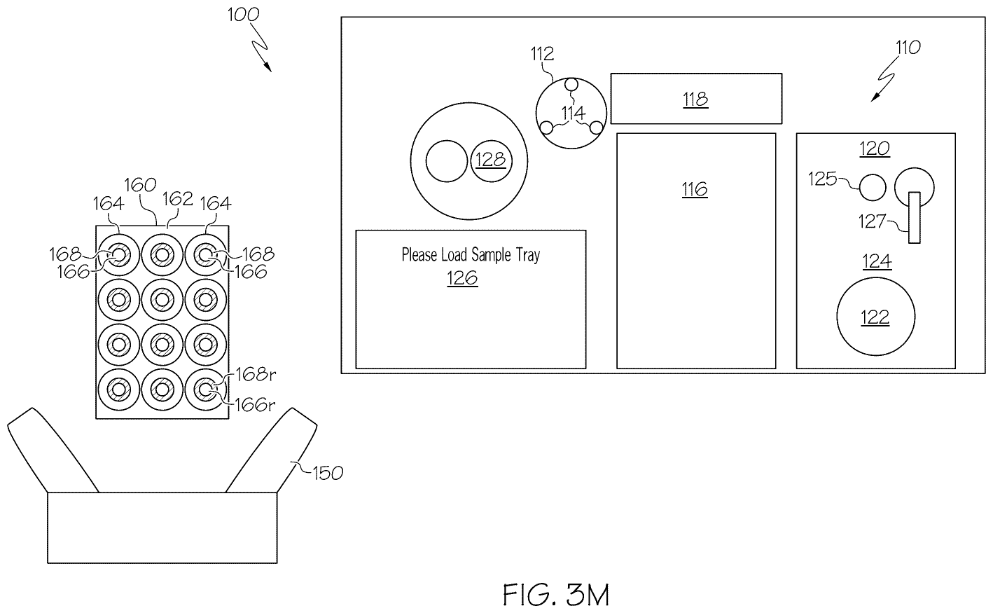

FIG. 3A depicts a first step in a second workflow using the thermal analysis system 100 of FIG. 1, in accordance with one embodiment. Like the previous process, a user 150 or lab technician is shown holding a sample tray 160 for thermal analysis. The sample tray 160 may be the same type of sample tray 160 used in the previous process shown in FIG. 2A-2P. Thus, the sample tray 160 includes a tray body 162 having a plurality of wells 164. Each well is configured to receive a sample pan 166 and a sample lid 168 therein. As described within the workflow, the sample pan 166 is configured to receive a sample for thermal analysis. The sample lid 168 is configured to be crimped to the sample pan 166 to create a seal between the sample lid 168 and the sample pan 166. The tray body 162 and/or the sample tray 160 is configured to be received into the thermal analysis system 100 and/or the automated sample preparation system 110 thereof to prepare the sample for thermal analysis. In the first step of the workflow, the user or lab technician peels open a sealing film that, prior to peeling off, seals and covers each of the plurality of wells in the sample tray 160. Further, shown in the first step, the user interface 126 of the thermal analysis system 100 includes instructions to the user 150 to load the sample tray 160 into the tray module 116.

FIG. 3B depicts a second step in the second workflow using the thermal analysis system 100 of FIG. 1, in accordance with one embodiment. In this step, the user 150 or lab technician places the sample tray 160 within the tray module 116 of the automated sample preparation system 110. The tray cover 118 is shown in an open position, exposing the sample tray 160 to the autosampler 112 and the gripping system 114 thereof. Unlike the workflow shown in FIG. 2A-2P, the user 150 or lab technician places the sample tray 160 within the tray module 116 without any samples located therein. While not shown, the second workflow may include a “start step” like that described hereinabove in the fourth step of the first workflow.

FIG. 3C depicts a third step in the second workflow using the thermal analysis system 100 of FIG. 1, in accordance with one embodiment. During this step, the autosampler 112 picks up and moves the picked up pan 166, using the three-axis movement system, over the balance module 122. The autosampler 112 places the pan into the adapter top of the balance module 122. At this point, the pan 166 does not include a sample. The weight of the pan is then measured and recorded.

FIG. 3D depicts a fourth step in the second workflow using the thermal analysis system 100 of FIG. 1, in accordance with one embodiment. During this step, the user 150 or lab technician may load sample 170 into the pan 166 while the pan 166 is located at the balance module 122. During this loading process, the display of the user interface 126 may be configured to display the current weight of the sample being loaded, along with a target weight of the amount of sample which should be added to the pan 166. At this point, the user 150 has not added enough of the sample 170, so the display of the user interface 126 directs the user 150 to add more of the sample 170. During this weighting process, the autosampler 112 has moved away from the balance module 122 to provide the user 150 with working space to add sample to the pan 166 on the balance module 122.

FIG. 3E depicts a fifth step in the second workflow using the thermal analysis system 100 of FIG. 1, in accordance with one embodiment. At this step, the user 150 has loaded the proper amount of the sample 170 into the pan 166 on the balance module 122. This has been indicated on the display of the user interface 126. The weight of the pan and the sample is then recorded.

FIG. 3F depicts a sixth step in the second workflow using the thermal analysis system 100 of FIG. 1, in accordance with one embodiment. At this point, the autosampler 112 moves back above the tray module 116 to pick up the lid 168 located in the same well 164 as the previously picked up pan 166 (i.e., the top left well 164). The lid 168 may be stored within the well 164 below the pan 166, for example, when the sample tray 160 is manufactured and packaged, and/or when the sample tray 160 is loaded into the tray module 116. The lid 168 that has been picked up by the gripping system 114 of the autosampler 112 is moved back to the balance module 122 and placed onto the top of the pan 166 prior to moving the pan 166 and lid 168 to the crimper module 124. The weight of the pan and the sample and the lid is then recorded.

FIG. 3G depicts a seventh step in the second workflow using the thermal analysis system 100 of FIG. 1, in accordance with one embodiment. In this step, the pan 166 is once again picked up by the gripping system 114 of the autosampler 112, removing the pan 166 and placed but unattached lid 168 from the balance module 122. The autosampler 112 moves from the balance module 122 to the crimper module 124. The autosampler 112 places the pan 166 and the unattached lid 168 onto the lower crimp 125 of the crimper module 124 and crimping is performed by the crimper module 124. During this step, the upper crimp 127 is rotated so that the upper crimp 127 is directly over the lower crimp 125. In some embodiments contemplated, the upper and lower crimps 127, 125 then converge at a high enough force or pressure to cause cold welding between circumferential flanges of each of the pan 166 and the lid 168 and provide for hermetic sealing, although embodiments are not limited to cold sealing and/or hermetic sealing. During the crimping process, the autosampler 112 is moved away from the crimper module 124. While not shown, the autosampler 112 may perform steps 3-6 of the second workflow on a second pan during the crimping process. Alternatively, the process may complete preparation of a first pan before moving onto a second pan.

FIG. 3H depicts a eighth step in the second workflow using the thermal analysis system 100 of FIG. 1, in accordance with one embodiment. During this step, the sealed pan 166 with the weighed sample is returned to the top left position in the sample tray 160 by the gripping system 114 of the autosampler 112. Once returned, the user interface 126 displays a message to the user that the first sample 170 is ready for testing in the first pan 166 (i.e., the top left pan).

FIG. 3I depicts a ninth step in the second workflow using the thermal analysis system 100 of FIG. 1, in accordance with one embodiment. This “step” in the workflow represents the repeating of steps 3-8 of the above-described second workflow on the various other pans 166 within the sample tray 160. The sample tray 160 may be a 40 pan tray, for example, having a single reference pan and 39 sample pans. However, any tray configuration having any number of pans is contemplated.

FIG. 3J depicts a tenth step in the second workflow using the thermal analysis system 100 of FIG. 1, in accordance with one embodiment. Here, the prepared samples are then tested using the thermal sensing system 128. In particular, each of the first sample (i.e., the top left sample pan 166) and the reference pan (i.e., the bottom right pan 166r) are loaded into the sensing system 128 automatically using the gripping system 114 of the autosampler 112. The tray cover 118 may automatically extend over the tray module 116 during this step, in order to protect the other samples within the sample tray 160 that are not under test. The sensing system may be a DSC sensing system, for example. The test is run on the first sample 170 within the first pan 166, and the test results may be displayed on the display of the user interface 126.

FIG. 3K depicts an eleventh step in the second workflow using the thermal analysis system 100 of FIG. 1, in accordance with one embodiment. Optionally, the autosampler 112 may be configured to provide the pan 166 of the tested sample 170 back to the balance module 122 for post-testing weighing, if necessary, whereby the sample weight change and/or weight loss may be determined using the weight found by the balance module 122 and the original weight stored by the computer system 130. This weight loss is displayed by the display of the user interface 126.

FIG. 3L depicts a twelfth step in the second workflow using the thermal analysis system 100 of FIG. 1, in accordance with one embodiment. This “step” in the workflow represents the repeating of steps 13 and optionally 14 of the above-described workflow on the various other pans 166 within the sample tray 160. Once all of the tests are completed, the display of the user interface 126 displays an “all tests completed” message. It should be understood that the testing data associated with each sample at each position within the sample tray 160 may be stored within the computer system 130 where the test results are associated with the tray position.

FIG. 3M depicts a thirteenth step in the second workflow using the thermal analysis system 100 of FIG. 1, in accordance with one embodiment. At this step, the user 150 or lab technician may then remove the sample tray 160 from the tray module 116. The user 150 or lab technician may then add another sample tray to begin a new preparation and/or testing procedure.

FIG. 2A-2P describe a workflow in which samples are provided from a sample bank into each pan 166 within the sample tray 160. This may be a particularly applicable process when the sample is in pre-created pellet form, for example. In contrast, FIG. 3A-3M describe a second workflow in which a sample is provided to a pan 166 by a user when the pan 166 is located at the balance module 122. In the second workflow, the balance module 122 may assist in the sample loading process by ensuring that a correct weight of sample is provided manually into the pan 166. This second workflow may be particularly advantageous in situations when a sample is not in pre-created portions, but requires user apportionment.

While not shown, a third workflow is also contemplated in which the sample is loaded robotically into the appropriate sample pans. This robotic process may occur prior to loading the sample tray 160 into the tray module 116 of the thermal analysis system 100. In other words, this robotic process may replace the second step of the first workflow shown in FIG. 2A. A robotic process contemplated may utilize an additional robotic system, such as an automated Andrew Alliance Andrew+Robot, an SLAS compliant robot, or any other appropriate lab robot system. In a still additional embodiment, an additional robotic system may be used to load a sample into a pan while the pan is located at the balance module 122. In such an embodiment, the robot would replace the manual sample loading process described in step four of the second workflow shown in FIG. 3D. Such processes may even further reduce the manual labor required in the sample preparation process.

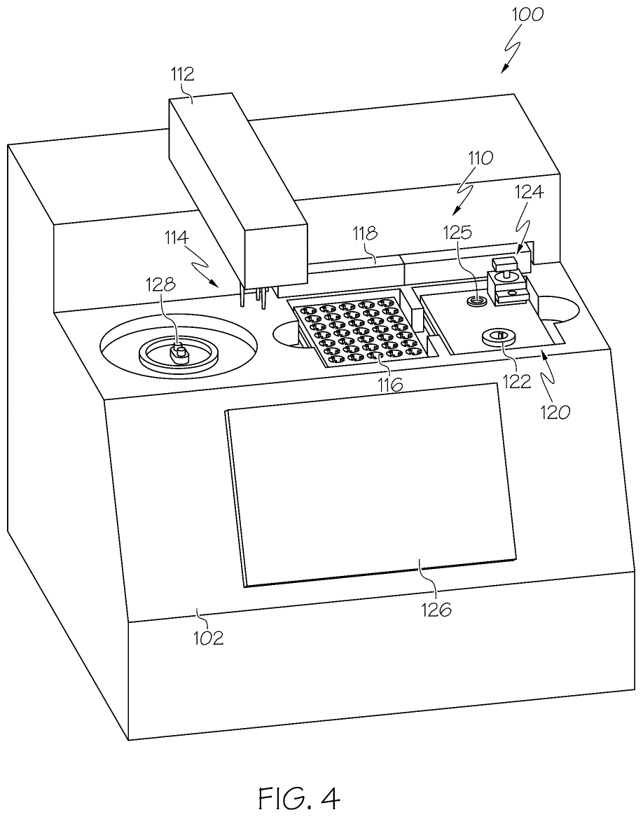

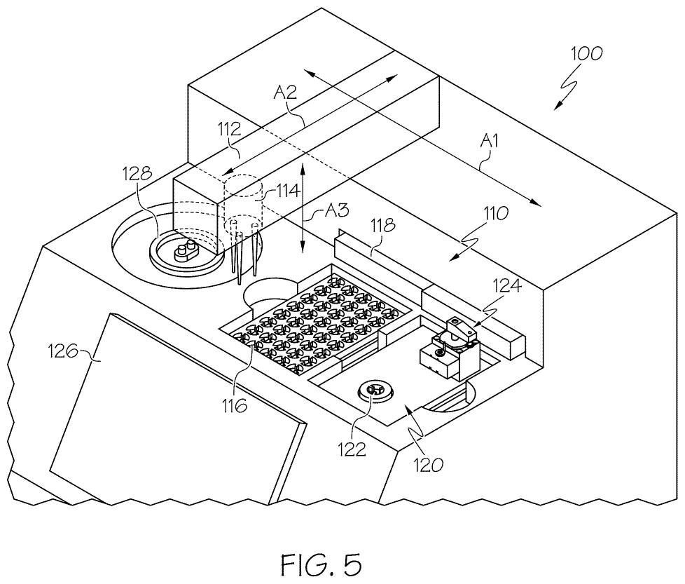

FIGS. 4 and 5 each depict perspective views of the thermal analysis system 100, in accordance with one embodiment. These views show an example of the system 100 shown schematically in FIG. 1-3M hereinabove. In particular, the thermal analysis system 100 includes the automated sample preparation system 110 including the autosampler 112 having the automated gripping system 114, the tray module 116 including the retracted tray cover 118, the sample preparation module 120 including the balance module 122 and the crimper module 124 having the lower crimp 125 and the upper crimp 126. The thermal analysis system 100 and/or automated sample preparation system 110 is shown further including the user interface 126, which may be a touch screen display device configured to receive inputs from users. Further, the thermal analysis system 100 includes the thermal sensor system 128 having a sample pan seat configured to receive a sample pan for testing, and a reference pan seat configured to receive a reference pan for testing. The thermal analysis system 100 includes a base or housing 102 configured to house the various components, computerized systems, motors, controllers, and the like configured to operate the thermal analysis system as described herein, including the computer system 130 shown in FIG. 1.

Further, as particularly shown in FIG. 5, the gripping system 114 and/or autosampler 112 is shown capable of moving along three axis, an X-axis denoted A1, a Y-axis denoted A2, and a Z-axis denoted A3. The autosampler 112 may be a multi axis moving component configured to move along the X-axis A1 to the left and right of the thermal analysis system 100. The autosampler 112 may further be configured to move along the second Y-axis A2 to the top and bottom of the thermal analysis system 100. The autosampler 112 and/or the gripping system 114 thereof may further be configured to move along the third Z-axis A3 which may move the gripping system 114 toward (downward) and away (upward) from the working surface(s) of the thermal analysis system 100.

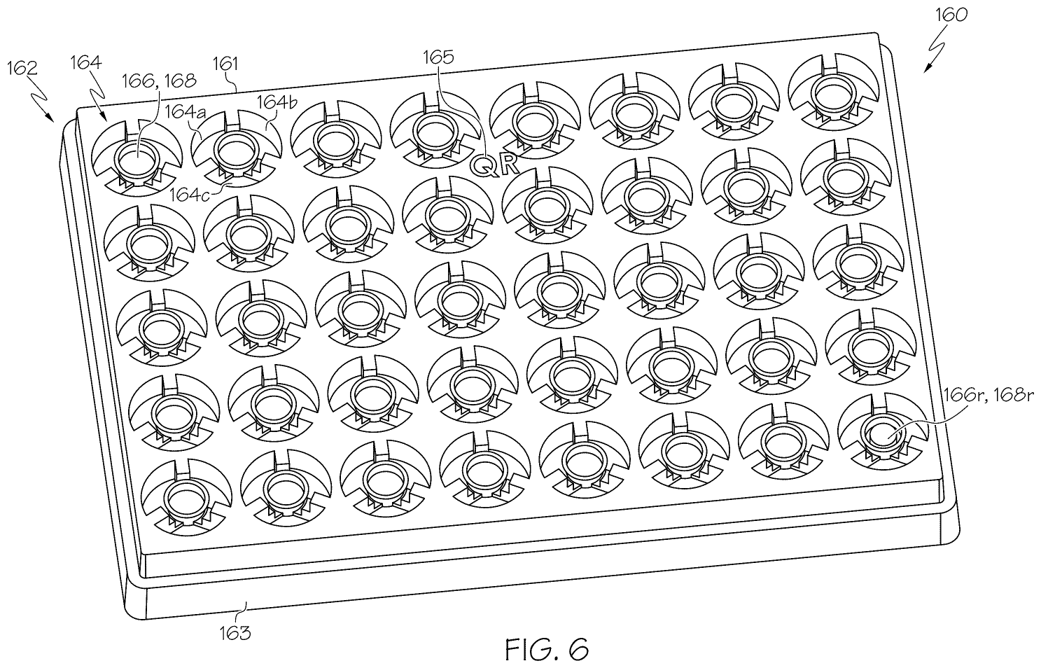

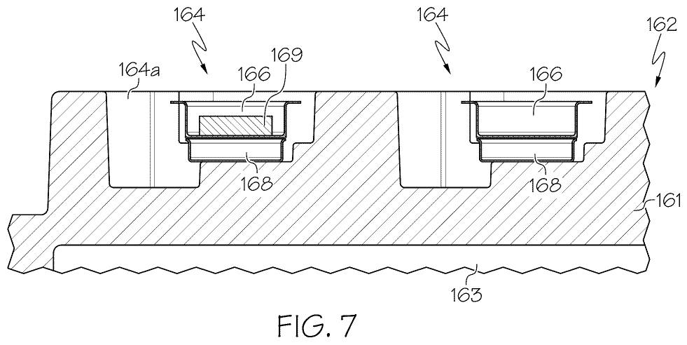

FIG. 6 depicts a perspective view of the sample tray 160 for the thermal analysis system 100 of FIG. 4, in accordance with one embodiment. The sample tray 160 may include the various features described in the sample tray 160 shown schematically in FIG. 2A-3M herein above. Thus, the sample tray may include the tray body 162 having a plurality of wells 164. Each individual well 164 is configured to receive an in individual sample pan 166 and an individual sample lid 168 therein. Each of the sample pans 166 shown may be configured to receive a sample for thermal analysis. However, it should be understood that the sample pans 166 are empty in the view shown. The sample lid 168 is hidden below each sample pan 166 in each well 164 of the sample tray 160, as shown in the side cross sectional view of FIG. 7. The sample lid 168 and sample pan 166 combination located in each well 164 may be configured to be crimped together to create a seal between the outer flanges thereof. Moreover, the tray body 162 and/or the sample tray 160 is configured to be received into the thermal analysis system 100 and/or the automated sample preparation system 110 thereof to prepare the sample for thermal analysis. While not shown, the sample tray 160 may include a peel-off sealing film that seals and covers each of the plurality of wells 164 and the pans 166 and lids 168 therein.

Each of the plurality of wells 164 includes a plurality of reliefs 164a, 164b, 164c each located radially about a central pan receiver location holding the pans 166. Each of the plurality of reliefs 164a, 164b, 164c may be each configured to facilitate receiving a finger 114a, 114b, 114c of the automated gripping system 114, as shown more particular, in FIG. 8.

The sample tray 160 further includes an identification code 165 located on the tray body 162 in a location viewable by a vision system which may be attached to the autosampler 112 of the automated sample preparation system 100, for example. In one case, the identification code is an embedded QR code located on the tray body 162.

The tray body 162 may include an upper body 161. The upper body 161 may be an injection molded thermoplastic body, for example, although this embodiment is not limiting. The upper body 161 may be located above base layer 163. The base layer 163 may be a metallic base layer, although this material is not limiting. The upper body 161 may be coupled to the metallic base layer 163.

In various embodiments, the tray body 162 may be Society for Laboratory Automation and Screening (SLAS) compatible. In various embodiments, the sample tray 160 may be reuseable, returnable, recyclable, and/or disposable/compostable. As shown, the plurality of wells 164 of the sample tray 160 may be located in a two-dimensional array having a plurality of rows and a plurality of columns. In the embodiment shown, forty wells 164 are included in the tray, arrayed with five rows and eight columns. This array may allow for the sampling of 39 different samples, in the case that the last well at the bottom right, for example, holds a reference pan and lid combination 166r, 168r.

Methods of manufacturing the tray body, such as the tray body 162, are contemplated which include injection molding a tray body including a plurality of wells wherein each well is configured to receive a sample pan and a sample lid. In various, the sample tray 160 may be manufactured in a manner in which the tray is pre-filled with one or both of a refence or test sample and/or pre-weighed (either with a reference and/or test sample or with only pans and/or lids) at the manufacturing site of the sample tray 160. Still further, the sample tray 160 may then be sealed at the manufacturers site after the pre-filling and/or pre-weighing thereof. This seal may be provided by the peel-off sealing film that seals and covers each of the plurality of wells 164 and the pans 166 and lids 168 therein.

FIG. 7 depicts a side cutaway view of two wells 164 of the automation tray 160 of FIG. 6, in accordance with one embodiment. Each of the wells 164 includes a sample pan 166 and a sample lid 168 located below the sample pan 166 in the well 164. The sample pan 166 located in the left well 164 includes an optional reference sample 169 therein (e.g., Indium).

FIG. 8 depicts an enlarged perspective view of the gripping system 114 including the various gripping fingers 114a, 114b, 114c picking up a pan 166 from a well 164 in the automation 160 tray of FIG. 6, in accordance with one embodiment. In particular, each gripping finger 114a, 114b, 114c is located within a respective relief 164a, 164b, 164c in order to switch between an open position, where the fingers 114a, 114b, 114c are located in a wider position that is radially away from the pan 166 but remain within the respective relief 164a, 164b, 164c, and a closed position, where the fingers 114a, 114b, 114c radially close about the pan 166.

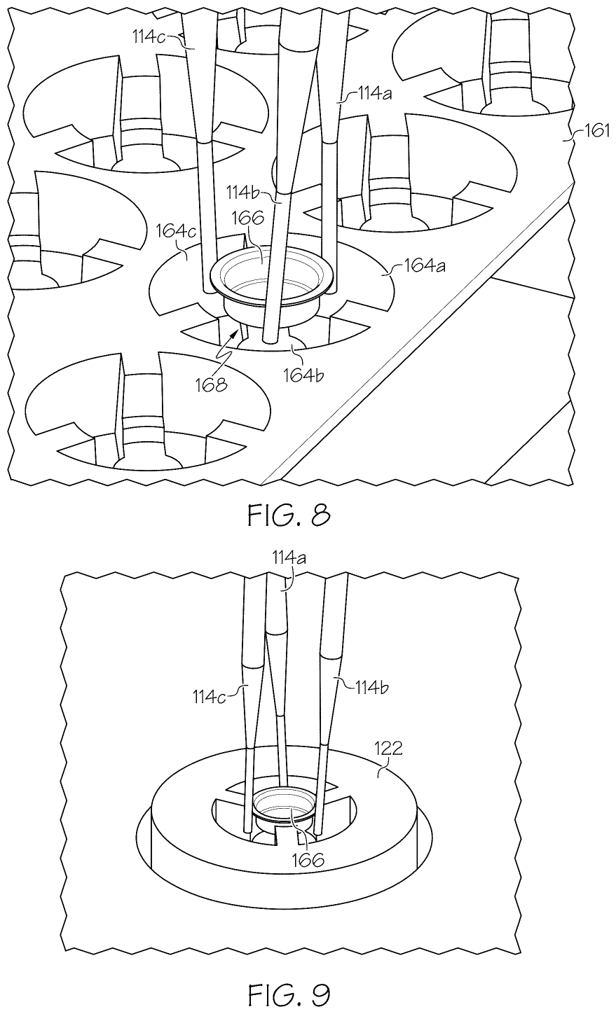

FIG. 9 depicts a perspective view of the gripping system 114 of FIG. 8 placing the pan 166 into a balance module system 122, in accordance with one embodiment. In particular, the balance module system is shown including an adapter top that may be dimensionally the same or similar to the well 164, having various reliefs configured to accommodate the fingers 114a, 114b, 114c.

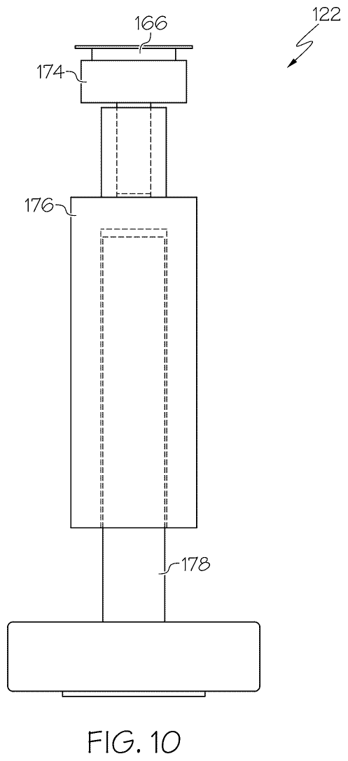

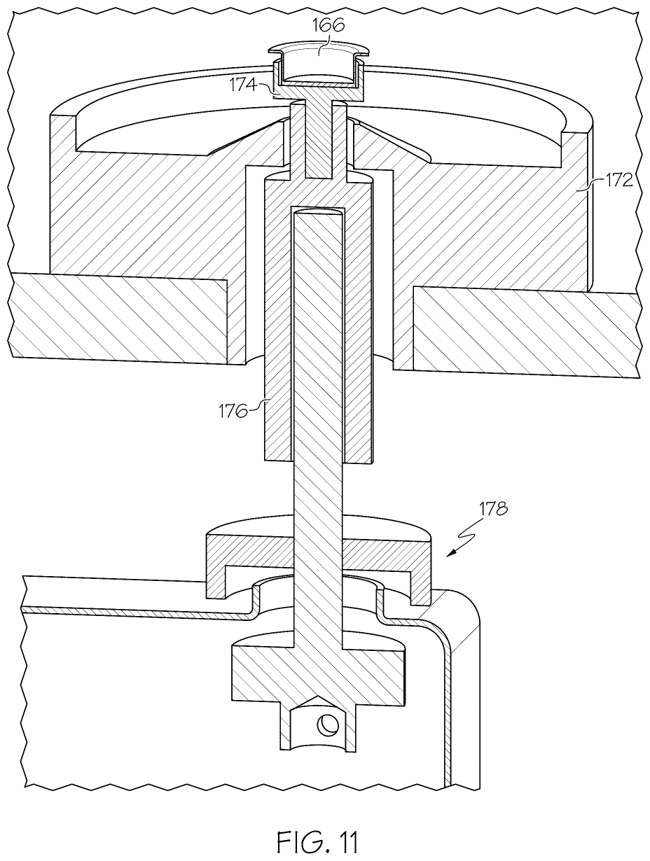

FIG. 10 depicts a side view of a balance module 122, in accordance with one embodiment. FIG. 11 depicts a side cutaway view of the balance module 122 of FIG. 10, in accordance with one embodiment. The balance module 122 is shown holding a pan 166 in an adapter top 174 which is operably attached to an adapter bottom 176. The balance module 122 includes a balance stem 178 extending from a balance system 179. The balance module 122 may be configured to receive the pan 166 from the autosampler 112 and perform weight measurement on the pan 166 and/or any sample located therein. The balance system 179 may be operably connected to sensors configured to sense weight placed on the adapter top 174 in the manner described herein.

The computer system 160 shown in FIG. 1 may be in operable communication with the balance module 122. The computer system 130 may be configured to maintain a database storing weight measurements performed by the balance module 122 and associate the weight measurements with a particular location (e.g., top left, etc.) of the well 164 in the sample tray 160. The display of the user interface 126 may thereby be configured to display a current weight of sample located in the pan 166 as being measured by the balance module 122. Simultaneously, the display may be configured to display a desired weight for testing, as known by the computer system 130 based on the input test scheme and/or the input and/or sensed type of tray provided to the tray module 116. During weighing by the balance module 122, the display may also be configured to display a message that the desired weight for testing has been reached when the current weight of the sample is at the desired weight within a predetermined margin.

The balance module 122 may be configured to output, and the computer system may be configured to receive a balance signal. The balance module 122 and/or computer system 130 may include a filter system configured to filter out temporary deviations in the balance signal from the balance module 122 caused by normal operational system vibrations, such as from movement in the room or movement of the machine (e.g., movement of the autosampler 112). Using this filter system, for example, the balance module 122 may be configured to weigh sample within the sample tray with at least a 0.1 mg accuracy accounting for normal operational system vibrations.

As shown in FIG. 11, the balance module 122 may optionally include an overspill tray 172 disposed about the balance module 122. Any sample which drops or is otherwise located on the overspill tray 172 may be configured to not impact weight measurement with the balance module 122. The overspill tray 172 may be removable from the balance module 122 for cleaning, for example.

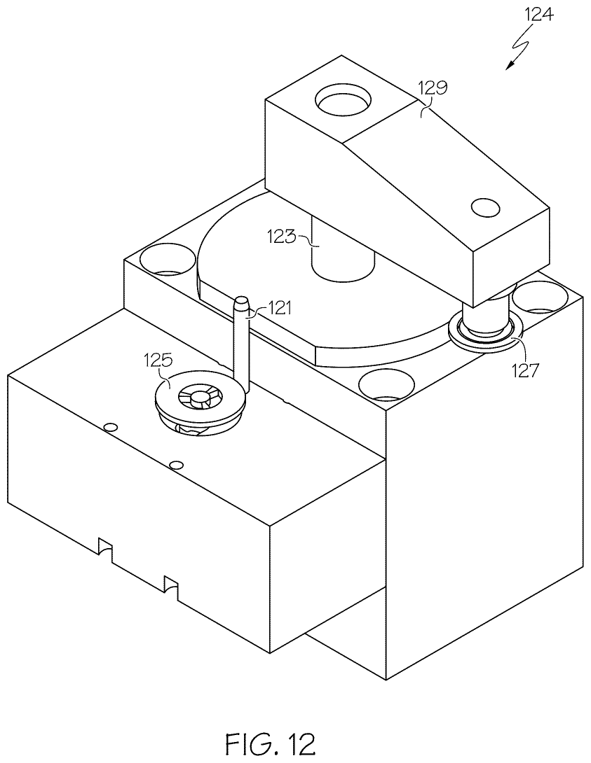

FIG. 12 depicts a perspective view of a crimper module 124 of the thermal analysis system 100 of FIG. 4-5, in accordance with one embodiment. The crimper module 124 may be configured to seal a sample pan configured for thermal testing, such as one of the pans 166, with an automated crimping process.

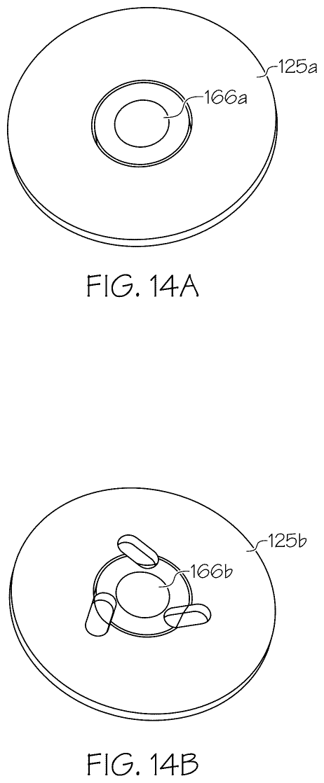

The automated crimping module 124 further includes an upper crimp 127 and a lower crimp 125. The automated crimping module 124 may be configured to compress the upper and lower crimps 127, 125 to cold weld a flange of the pan with a flange of the lid to create a hermetic seal between the flanges of the lid and the pan. One or both of the upper crimp 127 and the lower crimp 125 may be configured to receive a crimp adapter, such as the adapter dies 125a, 125b, 125c shown in FIG. 14A-14C. The adapter may be configured to crimp the pan and lid. Thus, the crimping module 124 may be configured to provide any type of crimp for any type of sample pan for thermal analysis.

The crimping module 124 includes an axis 123 about which a rotatable swing away load arm 129 may be configured to rotate. The rotatable swing away load arm 129 may include the upper crimp 127 extending away therefrom. In an open position, the rotatable swing away load arm 129 may be rotate about 90 degrees from a home position where the upper crimp 127 is above the lower crimp 125. In the open position shown, the upper crimp 127 is not above the lower crimp 125, exposing the lower crimp 125 so that a pan may be placed into position on the lower crimp 125. Further shown is an alignment pin 121 configured to align the rotatable swing away load arm 129 at the home position above the lower crimp 125.

The computer system 130 may be in operable communication with the automated crimping module 124. The computer system 130 may be configured to receive inputs from a user and control the automated crimping module 124, including the rotatable swing away load arm 129, and the compression of the upper and lower crimps 127, 125.

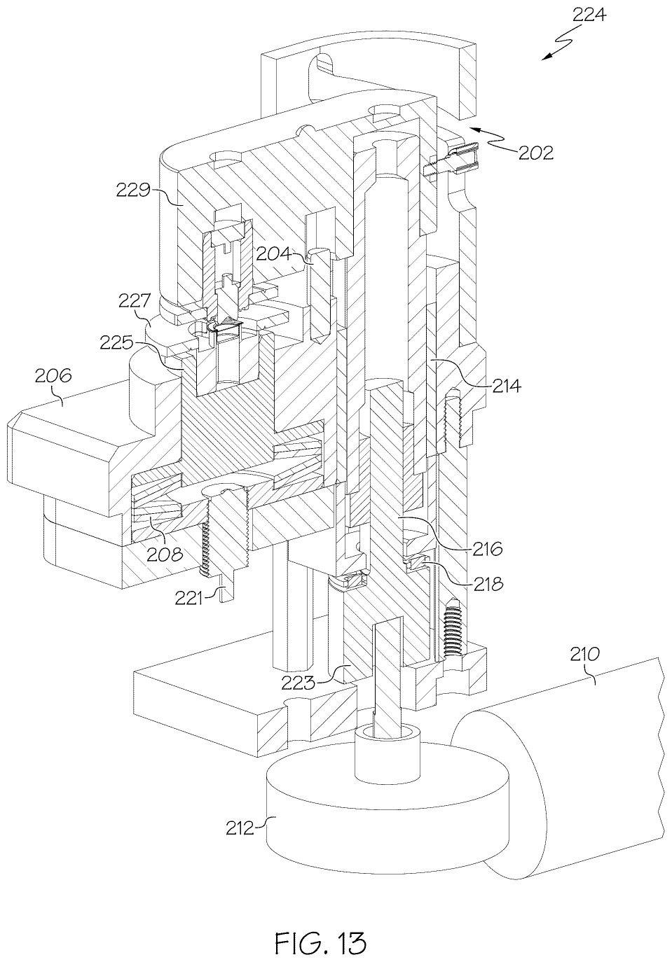

FIG. 13 depicts a side cutaway view of the another automated crimping module 224, in accordance with one embodiment. The automated crimping module 224 may be the same or similar to the automated crimping module 124 and may be incorporated into the thermal analysis system 100 described herein. The automated crimping module 224 may include an upper crimp 227 and a lower crimp 225. The automated crimping module 224 may be configured to compress the upper and lower crimps 227, 225 to cold weld a flange of the pan with a flange of the lid to create a hermetic seal between the flanges of the lid and the pan. One or both of the upper crimp 227 and the lower crimp 225 may be configured to receive a crimp adapter, such as the adapter dies 125a, 125b, 125c shown in FIG. 14A-14C. The adapter may be configured to crimp the pan and lid. Thus, the crimping module 224 may be configured to provide any type of crimp for any type of sample pan for thermal analysis.

The crimping module 224 may include an axis 223 about which a rotatable swing away load arm 229 may be configured to rotate. The axis 223 may be a lead screw, for example, and may be configured with low friction. The rotatable swing away load arm 229 may include the upper crimp 227 operably coupled thereto extending away therefrom. In an open position, the rotatable swing away load arm 229 may be rotate about 90 degrees from a home position where the upper crimp 227 is above the lower crimp 225 (as shown). In the open position (not shown), the upper crimp 227 is not above the lower crimp 225, exposing the lower crimp 225 so that a pan may be placed into position on the lower crimp 225. Further shown is an alignment pin 204 configured to align the rotatable swing away load arm 229 at the home position above the lower crimp 225. The alignment pin may include a high alignment accuracy (e.g., less than 100 μm alignment accuracy).

The lower crimp 225 includes a chassis body 206 which may be configured with a high stiffness to enable high loads from the crimping module 224. The chassis body 206 may include spring mechanism 208 within. As shown, the spring mechanism 208 is operatively coupled to the lower crimp 225 to provide a spring suspension thereof. In the embodiment shown, the spring mechanism 208 may include four springs. Thus, the lower crimp 225 may include a spring chassis. The spring mechanism 208 may further be operatively coupled to a precision stop switch 221. The precision stop switch 221 may be calibrated to, for example, a specific amount of force.

The automated crimping module 224 further includes a guided roller bearing 202 to create rotation of at least one of the upper and lower crimp 227, 225 during crimping. In the embodiment shown, the guided roller bearing 202 may guide rotation of the upper crimp 227. Rotation may be facilitated by a bushing 214. The bushing 214 may be a bronze linear bushing to reduce friction. The bushing 214 may be relatively stiff.

The automated crimping module 224 includes a worm gear driven motor 210 with an encoder 212 for controlling the automated crimping module. The worm gear driven motor 210 may include a 10 Nm capacity. A lead screw 216 may be operably connected to an output of the worm gear driven motor 210. The lead screw 216 may be, for example, a low friction oversized ⅜″ lead screw. A roller bearing 218 having a high bearing capacity (e.g., 1200 lb.) may operate to facilitate movement of the lead screw 216.

FIG. 14A depicts a perspective view of a Hermetic die 125a holding a pan 166a located therein, in accordance with one embodiment. FIG. 14B depicts a perspective view of a modified die 125b holding a pan 166b, in accordance with one embodiment. Any type of die, such as the Hermetic die 125a and the modified die 125b may be placed within the lower crimp 125, 225 of the crimping modules 124, 224 described hereinabove.

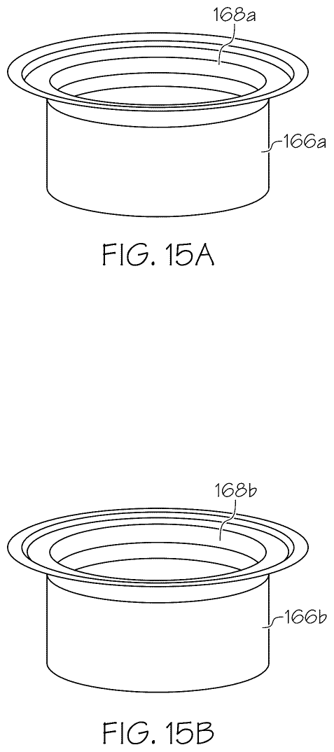

FIG. 15A depicts a perspective view of a crimped pan and lid combination 166a, 168a crimped by the die of FIG. 14A, in accordance with one embodiment. FIG. 15B depicts a perspective view of a pan and lid combination 166b, 168b crimped by the modified die of FIG. 14B, in accordance with one embodiment. While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A sample tray for thermal analysis comprising:
a tray body including a plurality of wells, wherein each well is configured to receive a sample pan and a sample lid,
wherein the sample pan is configured to receive a sample for thermal analysis, wherein the sample lid is configured to be crimped to the sample pan to create a seal between the sample lid and the sample pan,
wherein the tray body is configured to be received into an automated sample preparation system to prepare samples for thermal analysis.

2. The sample tray of claim 1, wherein the sample lid is configured to be retained below the sample pan in each well.

3. The sample tray of claim 1, further comprising:
a plurality of sample pans, each individually located within one of the plurality of wells of the tray body.

4. The sample tray of claim 3, further comprising:
a plurality of sample lids, each individually located within one of the plurality of wells of the tray body.

5. The sample tray of claim 4, wherein each of the plurality of sample lids are located below one of the plurality of sample pans within each of the plurality of wells.

6. The sample tray of claim 1, further comprising a peel-off sealing film that seals and covers each of the plurality of wells.

7. The sample tray of claim 1, wherein each of the plurality of wells includes a plurality of reliefs each located radially about a central pan receiver location, wherein the plurality of reliefs are each configured to facilitate receiving a finger of an automated gripping system.

8. The sample tray of claim 7, wherein each of the plurality of wells includes three reliefs each equally spaced about the central pan receiver location.

9. The sample tray of claim 1, further comprising an identification code located on the tray body in a location viewable by a vision system of the automated sample preparation system.

10. The sample tray of claim 9, wherein the identification code is an embedded QR code, barcode or numerical ID located on the tray body.

11. The sample tray of claim 1, wherein the tray body is an injection molded thermoplastic body.

12. The sample tray of claim 11, further comprising a metallic base layer, wherein the tray body is coupled to the metallic base layer.

13. The sample tray of claim 1, wherein the tray body is Society of Laboratory and Automation (SLAS) compatible.

14. The sample tray of claim 1, wherein the plurality of wells are located in a two dimensional array having a plurality of rows and a plurality of columns.

15. A sample tray for thermal analysis comprising:
a tray body including a plurality of wells;
a plurality of sample pans, each individually located within one of the plurality of wells of the tray body; and
a plurality of sample lids, each individually located within one of the plurality of wells of the tray body,
wherein each of the plurality of sample lids are located below one of the plurality of sample pans within each of the plurality of wells.

16. The sample tray of claim 15, further comprising a peel-off sealing film that seals and covers each of the plurality of wells.

17. The sample tray of claim 15, wherein each of the plurality of wells includes a plurality of reliefs each located radially about a central pan receiver location, wherein the plurality of reliefs are each configured to facilitate receiving a finger of an automated gripping system.

18. The sample tray of claim 17, wherein each of the plurality of wells includes three reliefs each equally spaced about the central pan receiver location.

19. The sample tray of claim 15, further comprising an identification code located on the tray body in a location viewable by a vision system of the automated sample preparation system.

20. A method of manufacturing a sample tray for thermal analysis comprising:
injection molding a tray body including a plurality of wells wherein each well is configured to receive a sample pan and a sample lid,
wherein the sample pan is configured to receive a sample for thermal analysis, wherein the sample lid is configured to be crimped to the sample pan to create a seal between the sample lid and the sample pan,
wherein the tray body is configured to be received into an automated sample preparation for thermal analysis.
